(19) United States
(12) Patent Application Publication
(10) Pub. No.: US 2025/0045674 A1
(43) Pub. Date: Feb. 6, 2025

(54) SUSTAINABILITY OPTIMIZER PLUGIN

(71) Applicant: International Business Machines Corporation, Armonk, NY (US)

(72) Inventors: Kumar Saurav, Bhojpur (IN); Ayush Jain, Lucknow (IN); Jagabondhu Hazra, Bangalore (IN)

(21) Appl. No.: 18/363,803

(22) Filed: Aug. 2, 2023

(51) Int. Cl. G06Q 10/0637; G06N 20/00; G06Q 10/04

(52) U.S. Cl. CPC G06Q 10/06375; G06N 20/00; G06Q 10/04

(57) ABSTRACT

Systems, computer-implemented methods, and/or computer program products are provided that facilitate integrating sustainability solutions into an organization's existing business model using artificial intelligence. A computer-implemented method comprises extracting, by a system comprising a processor, one or more objective functions of an enterprise system from defined business model data for the enterprise system, the one or more objective functions defining relationships between one or more processes of the enterprise system and one or more business objectives of the enterprise system. The method further comprises inferring, by the system, one or more sustainability costs related to the one or more processes using one or more first machine learning processes, and generating, by the system, a multi-objective optimization function for the enterprise system that formulates potential changes to the one or more processes as a function of balancing reducing the one or more sustainability costs and achieving the one or more business objectives.

### BACKGROUND

Organizations are becoming increasingly carbon aware and want to reduce their carbon footprint on the environment. However, there is often conflict between the business goals and the carbon goals. Strategies directed to maximizing the business objective often result in increasing the carbon footprint, and vice versa. Accordingly, techniques are needed to find the right balance between minimizing an organization's carbon footprint while achieving its business goals.

### SUMMARY

The following presents a summary to provide a basic understanding of one or more embodiments described herein. This summary is not intended to identify key or critical elements, or to delineate any scope of the particular embodiments or any scope of the claims. The sole purpose of the summary is to present concepts in a simplified form as a prelude to the more detailed description that is presented later. In one or more embodiments described herein, devices, systems, computer-implemented methods, apparatus and/or computer program products are described that can facilitate automatically integrating one or more sustainability solutions into an organization's existing business model using artificial intelligence (AI).

According to an embodiment, a system can comprise a memory that stores computer executable components and a processor that executes the computer executable components stored in the memory. The computer executable components can include an extraction component that extracts one or more objective functions of an enterprise system from defined business model data for the enterprise system, the one or more objective functions defining one or more processes of the enterprise system defined for achieving one or more business objectives of the enterprise system. The computer executable components can further include a sustainability analysis component that infers one or more sustainability costs related to the one or more processes using one or more first machine learning processes. The computer executable components can further include an optimization formulation component that generates a multi-objective optimization function for the enterprise system that formulates potential changes to the one or more processes as a function of balancing reducing the one or more sustainability costs and achieving the one or more business objectives.

In some implementations, the computer executable components further comprise a training component and wherein the one or more first machine learning processes comprise training, via the training component, one or more sustainability models to classify different types of sustainability costs associated with different types of business objective functions and predict measures of influence of the different types of business objective functions on amounts of the different types of sustainability costs. The sustainability analysis component can employ the one or more sustainability models to predict respective types of the one or more sustainability costs related to the one or more processes and respective measures of influence of the one or more objective functions on respective amounts of the respective types of the one or more sustainability costs. In various embodiments, the different types of sustainability costs comprise different types of emission classes and the amounts correspond to emission amounts.

The computer executable components further comprise a training data generation component and wherein the one or more first machine learning processes comprise generating, via the training data generation component, a training dataset that maps the different types of sustainability costs associated with the different types of business objective functions and the measures of influence of the different types of business objective functions on the amounts of the different types of sustainability costs, and wherein the training comprises training the one or more sustainability models using the training dataset. In some implementations, generating the training dataset comprises parsing, via the training data generation component using one or more automated information parsing processes, open-source documents and sustainability report data associated with different types of business objective functions and extracting structured information correlating the different types of sustainability costs associated with the different types of business objective functions and the measures of influence of the different types of business objective functions to the amounts of the different types of sustainability costs.

In some implementations, the sustainability analysis component infers the one or more sustainability costs by modeling the one or more objective functions as one or more cost functions that formulate the one or more processes as a function of financial costs attributed to the one or more processes. The sustainability analysis component further adapts the one or more cost functions to reformulate the one or more processes as a function of the one or more sustainability costs based on the financial costs, the respective types of the one or more sustainability costs and the respective measures of influence.

In some embodiments, the computer executable components further comprise a solver application component that applies a solver to the multi-objective optimization function and generates different solutions to the multi-objective optimization function using the solver, the different solutions comprising information describing different changes of the potential changes and resulting impact data indicating how the different changes impact reducing the one or more sustainability costs and achieving the one or more business objectives. The computer executable components can further comprise a recommendation component that selects one or more changes of the different changes based on the impact data associated with the one or more changes satisfying a sustainability criterion and generates and provides an entity associated with the enterprise system recommendation data recommending performance of the one or more changes based on the selecting.

In some implementations, the computer executable components can further comprise a solver selection component that extracts problem characteristics of the multi-objective optimization function, and determines, using one or more second machine learning processes, estimated performance characteristics of different optimization problem solvers as applied to solve the multi-objective optimization function based on the problem characteristics. The solver selection component further selects a solver of the different optimization solvers for solving the multi-objective optimization function based an analysis of the estimated performance characteristics relative to one or more defined selection criteria.

To facilitate this end, the computer executable components further comprise a training component and wherein the one or more second machine learning processes comprise training, via the training component, one or more solver assessment models to predict performance characteristics of the different optimization problem solvers as applied to solve different types of optimizations problems based on known problem characteristics of the different types of optimization problems, known solver characteristics of the different types of optimization solvers, and known performance characteristics the different optimization problem solvers as applied to solve different types of optimizations problems. With these implementations, the solver selection component can employ the one or more solver assessment models to determine the estimated performance characteristics of the multi-objective optimization function based on the known solver characteristics and the problem characteristics of the multi-objective optimization function.

The computer executable components can further comprise a training data generation component and wherein the one or more second machine learning processes further comprise generating the training dataset for training the one or more solver assessment models by the training data generation component. To facilitate this end, the training data generation component can apply the different optimization problem solvers to solve the different types of optimizations problems to generate the known performance characteristics the different optimization problem solvers. The training data generation component can further extract the known problem characteristics of the different types of optimization problems based on analysis of the different types of optimization problems and extract the known solver characteristics of the different types of optimization solvers based on analysis of the different types of optimization solvers.

In some embodiments, elements described in the disclosed systems and methods can be embodied in different forms such as a computer-implemented method, a computer program product, or another form.

### DESCRIPTION OF THE DRAWINGS

FIG. 1 illustrates example, non-limiting system that can facilitate automatically integrating one or more sustainability solutions into an organization's existing business model using artificial intelligence (AI), in accordance with one or more embodiments described herein.

FIG. 2 illustrates a block diagram of an example, non-limiting computing system that can facilitate automatically integrating one or more sustainability solutions into an organization's existing business model using artificial intelligence (AI), in accordance with one or more embodiments described herein.

FIG. 3 illustrates a flow diagram of an example, non-limiting process for generating a multi-objective optimization (MOO) function for an enterprise system that integrates one or more sustainability objective functions with an existing business objective function for the enterprise system using AI, in accordance with one or more embodiments described herein.

FIG. 4 illustrates a flow diagram of an example, non-limiting machine learning process for generating one or more optimization solver assessment models in accordance with one or more embodiments described herein.

FIG. 5 illustrates a flow diagram of an example, non-limiting process for solving a MOO using AI, in accordance with one or more embodiments described herein.

FIG. 6 presents a graph illustrating a process of a logistics business in accordance with one or more example embodiments described herein.

FIG. 7 illustrates objective functions of a logistics business process formulated as financial cost functions and corresponding sustainability cost functions in accordance with one or more embodiments described herein.

FIG. 8 presents a graph illustrating the impact of different optimization solutions to a multi-objective optimization function integrating a suitability objective and a business objective in accordance with one or more embodiments described herein.

FIG. 9 illustrates a flow diagram of an example, non-limiting computer-implemented method for automatically integrating one or more sustainability solutions into an organization's existing business model using AI in accordance with one or more embodiments described herein.

FIG. 10 illustrates a flow diagram of another example, non-limiting computer-implemented method for automatically integrating one or more sustainability solutions into an organization's existing business model using AI, in accordance with one or more embodiments described herein.

FIG. 11 illustrates a flow diagram of another example, non-limiting computer-implemented method for automatically integrating one or more sustainability solutions into an organization's existing business model using AI in accordance with one or more embodiments described herein.

FIG. 12 illustrates a block diagram of an example, non-limiting operating environment in which one or more embodiments described herein can be facilitated.

FIG. 13 illustrates a block diagram of an example, non-limiting cloud computing environment in accordance with one or more embodiments described herein.

FIG. 14 illustrates a block diagram of a plurality of example, non-limiting abstraction model layers, in accordance with one or more embodiments described herein.

### DETAILED DESCRIPTION

The following detailed description is merely illustrative and is not intended to limit embodiments, application and/or uses of embodiments. Furthermore, there is no intention to be bound by any expressed and/or implied information presented in the preceding Background and/or Summary sections, and/or in this Detailed Description section.

As discussed above, organizations are becoming increasingly carbon aware and want to reduce their carbon footprint on the environment. However, businesses often have legacy optimization frameworks defined for their business models and adding an additional sustainability objective can be difficult and complicated, as there are often competing interests between existing business goals and sustainability goals, thus hindering adoption of sustainable business practices.

The disclosed techniques address this problem using artificial intelligence (AI) to automatically integrate one or more sustainability solutions into an organization's existing business model. In particular, the disclosed techniques provide a sustainability optimizer software application that uses AI to read and interpret the existing implementation of an organization's business model and add a sustainability objective to the business existing business model. For example, the sustainability objective can relate to casing environmental impact (e.g., reducing carbon emissions for example), facilitating the conservation of natural resources, and various other types of sustainability objectives, which can vary for different types of organizations. In some embodiments, the sustainability optimizer can automatically infer the sustainability objective or objectives applicable to the organization. Additionally, or alternatively, the particular sustainability objective or objectives targeted by a particular organization can be provided via user input.

The sustainability optimizer further configures the existing business model with the added sustainability objective as a multi-objective optimization (MOO) problem and solves the MOO using one or more existing optimization problem solvers without changing the existing frameworks deployed by the organization. The sustainability optimizer can further use AI to automatically detect the type of formulation of the MOO and choose the best solver or solvers available to solve the MOO problem. In association with solving the MOO problem, the sustainability optimizer can automatically generate and recommend different solution options for the organization that balance the organization's existing business goals, such as maximizing financial profits for example, and one or more added sustainability goals, such as reducing carbon emissions.

In this regard, the sustainability optimizer application can correspond to a plugin type application that can add a sustainability optimization function to an existing optimization framework used by an enterprise system. The sustainability optimizer application is further industry agnostic and can be used to add various types of sustainability objectives to various types of enterprise systems.

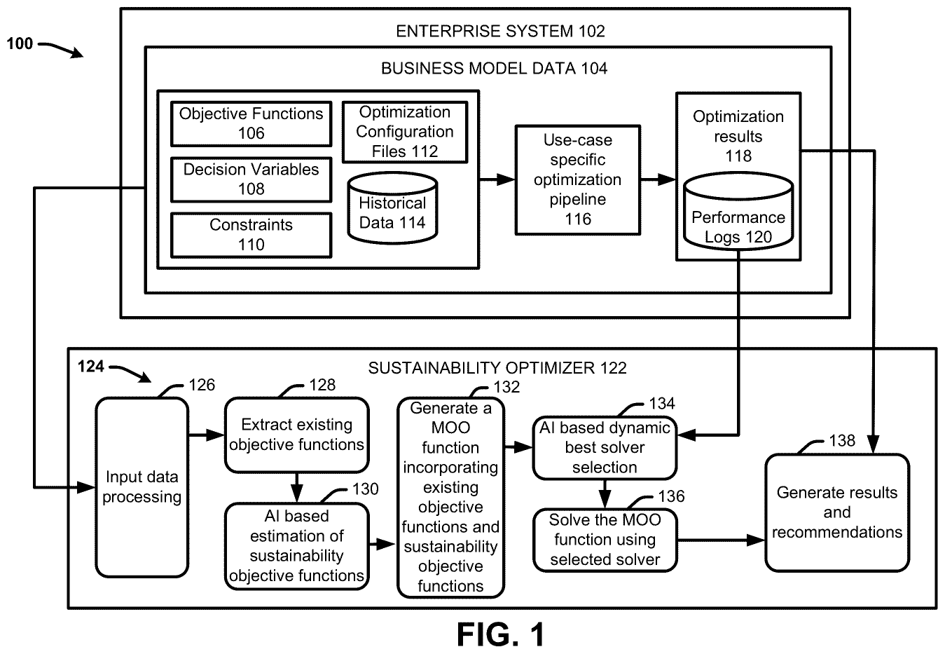

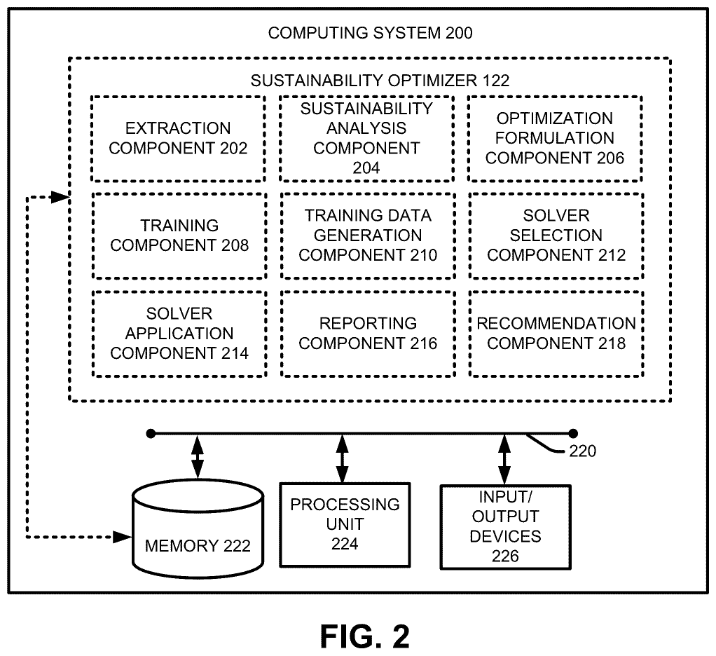

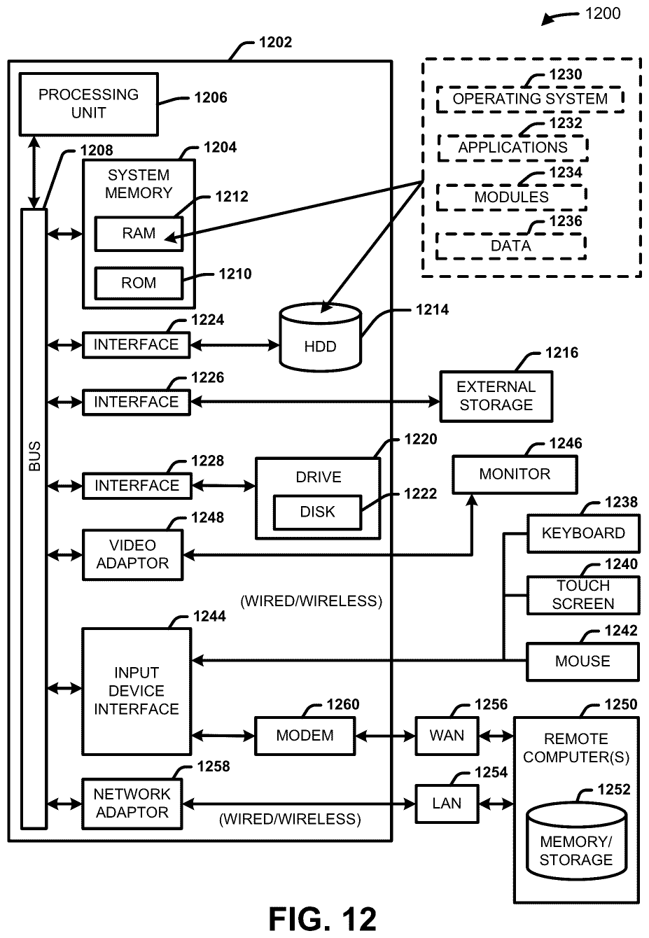

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details. Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems 100 and/or 200 illustrated at FIGS. 1 and 2, and/or systems thereof, can further comprise one or more computer and/or computing-based elements described herein with reference to an operating environment, such as the operating environment 1200 illustrated at FIG. 12. In one or more described embodiments, computer and/or computing-based elements can be used in connection with implementing one or more of the systems, devices, components and/or computer-implemented operations shown and/or described in connection with FIGS. 1 to 11 and/or with other figures described herein.

Turning now to FIG. 1, illustrated is an example, non-limiting system 100 that can facilitate automatically integrating one or more sustainability solutions into an organization's existing business model using AI, in accordance with one or more embodiments described herein. The non-limiting system 100 can include an enterprise system 102 and a sustainability optimizer 122. The sustainability optimizer 122 can correspond to and include one or more computer executable components that can be stored in memory associated with one or more computing systems (e.g., memory 222 of computing system 200, as shown in FIG. 2) and executed by one or more processors (e.g., processing unit 224) associated with the one or more computing systems (e.g., computing system 200) to perform the operations of the sustainability optimizer 122 as described herein. For example, in various embodiments, the sustainability optimizer 122 can include or correspond to a plugin type software application that can access (e.g., via any suitable wireless or wired communication network, such as the “Internet” or another suitable communication network) and process business model data 104 of an enterprise system and add a sustainability optimization function to an existing optimization framework used by an enterprise system 102.

Generally, the enterprise system 102 can correspond to one or more computing systems employed by a business or enterprise that provides business model data 104 for the enterprise system. The terms “enterprise system,” “business,” “business system,” “organization,” “company,” and the like are used herein to refer to any type of real-world system that performs one or more processes or operations using one or more tangible resources (e.g., physical resources, machines, computing resources, transportation resources, human resources, supplies/tools/equipment, natural resources, energy resources, etc.), to achieve one or more goals. For example, an enterprise system can include any type of business organization or enterprising entity engaged in commercial, industrial, or professional activity for the purpose of economic production of goods and/or services. The businesses can be for-profit entities whose primary goal is to produce a financial profit, or non-profit organizations fulfilling a charitable mission or furthering a social cause. Businesses range in scale and scope from sole proprietorships to large, international corporations. The type of enterprise system can vary and be associated with various industries, such as for example, energy, agriculture, transport, logistics, food and retail, construction, technology, forestry, medicine, fashion, and various others. In some embodiments, the enterprise system can correspond to a personal system associated with an entities' personal property operations, household and/or family operations, activities and/or life operations and routines. With these embodiments, the disclosed techniques can be applied to facilitate determining how to adjust managing and performing operations associated with the entities' personal property operations, household operations, activities, etc., to become more sustainable. As used herein, the terms “entity,” “user entity.” “user” and the like can be or include a machine, device, component, hardware, software, smart device or, in some embodiments, a human.

Regardless of the type of the enterprise system, the business model data 104 can include or correspond to information describing existing processes, operations, protocols, etc., used by the enterprise system to achieve one or more objectives of the enterprise system. In various implementations, the objectives of the enterprise system are referred to herein as “business objectives” however it should be appreciated that depending on the type of the enterprise system, the objectives may correspond to non-business objectives (e.g., increasing personal yields on a home garden, minimizing financial costs attributed to managing a family estate, etc.). The business model data 104 can also include or correspond to information that defines what resources are used by the enterprise system (e.g., physical resources (e.g., machines, computing resources, transportation resources, human resources, supplies/tools/equipment, etc.), logical resources (e.g., software), natural resources, energy resources, etc.), how they are used, costs involved, and so on. The business model data 104 can also include information that describes how the operations of the enterprise system are performed in accordance with an existing optimization framework to best achieve its business objectives.

In this regard, in some embodiments, the business model data 104 can include information defining one or more objective functions 106 of the enterprise system, the one or more objective functions 106 defining relationships between one or more existing business processes (and/or operations, protocols, etc.) of the enterprise system and one or more business objectives of the enterprise system. For example, the one or more objective functions 106 can define one or more existing business objectives of the enterprise system as formulated into mathematical functions that correlate relationships between decision variables 108 and constraints 110 of the one more existing business processes on the business objectives, such as making profits, achieving customer satisfaction/retention, providing quality of service, and other types of business objectives. The business model data 104 can also define the decision variables 108 and the constraints 110. In this regard, an objective function is a mathematical equation that describes how one or more processes of the enterprise system are used to achieve one or more business objectives. It then uses the correlation of variables and constraints to determine the value of the final outcome. In other words, it's a formula businesses can use to achieve profitability and other business goals. For example, an objective function for a business can include a mathematical representation of how variables and constraints of one or more processes or operations of the business impact one or more business goals, such as profits.

In association with optimizing an objective function, values of the variables and/or coefficients of the variables may be adjusted to maximize the business objective under the constraints, such as maximizing profits or minimizing losses. For example, the constraints could reflect the limitations of the environment in which the business operates, such as (but not limited to), resource constraints, operational constraints, technology constraints, time constraints, quality control constraints, legal constraints, and others. In some embodiments, the constraints may also define ranges of values and/or complex relationships between parameters that control how different variables and/or variable values can be adjusted in association solving the objective function as an optimization problem. In association with optimizing an objective function, each combination of values that can apply to the decision variables and satisfy the constraints forms a potential solution, with the combination that produces the best result on the business objective (e.g., greatest profits, lowest losses, etc.) generally being the best solution. In this regard, the objective functions 106 can mathematically define one or more existing processes of the enterprise system and how variables and constraints of the one or more existing processes relate to one or more business objective of the enterprise system.

The business model data 104 can also include optimization configuration files that include optimization configuration information defining one or more existing optimization configurations employed by the enterprise system for the one or more objective functions 106 to optimize the one or more defined business objectives. For example, the optimization configuration files 112 can define one or more combinations of values applied by the enterprise system for the decision variables 108 of the objective functions 106 that form existing solutions to the objective functions 106 under existing optimization criteria for the business objectives or targets represented by the objective functions. The optimization configuration files 112 can also define the optimization criteria. For example, the business objective may be to make profits and the optimization criteria may be to maximize profits. In another example, the business objective may be to make profits and the optimization criteria may be to maximize profits under a specific set of constraints tailored to a specific use case, such as for instance resource constraints, operational constraints, technology constraints, time constraints, quality control constraints, legal constraints, and others.

In many implementations, a business can have multiple different business objectives, which may be represented in the same objective function or separate objective functions. For example, as applied to a hospital organization, their business objectives may include making profits, providing quality care, and retaining highly rated clinicians. The optimization criteria for each individual objective naturally would be to maximize each objective. However, when combining multiple (e.g., two or more) objectives into a business model, the optimization problem becomes more complex as many maximizing one objective function may deter from maximizing another. Accordingly, solutions to the optimization problem typically become those which best balance maximizing all objective functions. With theses implementations, the optimization configuration files 112 can define the optimization configuration (or configurations) applied to the respective business objective functions as formulated as a MOO function (i.e., an optimization problem with two or more objective functions). For example, the optimization configuration files can define the optimization criteria, such as maximize and balance the respective objective functions, and the values of applied for the decision variables determined to achieve an existing optimal solution. The optimization criteria may also define preferred thresholds or threshold ranges (e.g., minimum values and preferred values) for the respective objective function targets (e.g., minimum profit value, preferred profit value, optimal profit value). In other words, the optimization criteria can define how the enterprise system can balance the two or more objectives, such to what degree the enterprise system may lower profits to decrease carbon emissions to a desired level, as applied to one example of a MOO function incorporating an added sustainability objective by the sustainability optimizer 122, which is the subject of the disclosed techniques.

The business model data 104 can also include historical data 114 that corresponds to historical business records of the enterprise system regarding operations performed and actual values of the business objectives observed over time (e.g., actual profits, actual losses, etc.), actual values of the decision variables observed and the like. For example, the historical data 114 can include information that tracks information associated with different resources and processes employed by the enterprise system, including information regarding costs associated (e.g., financial costs, sustainability costs, quality costs, etc.), historical performance assessment measures (e.g., key performance indicators (KPIs) regarding whether and to what degree respective business objectives were achieved), historical performance constraints involved (e.g., resource constraints, operational constraints, technology constraints, etc.), and the like.

The business model data 104 can also include information describing different use-case specific optimization pipelines 116 used by the enterprise system to generate one or more existing solutions to the one or more objective functions 106 in accordance with the existing, optimization configuration files 112. For example, the different use-cases can correspond to different processes and/or different optimization objectives, performed under different decision variable 108 and/or constraints 110 tailored to different use cases. The business model data 104 can also include optimization results 118 of the different use-case specific optimization pipelines, indicating whether and to what degree the respective pipelines impacted the corresponding business objectives. The optimization results 118 can also include performance logs 120 that include information describing measurable performance assessment values of optimization results 118 and/or the optimization solver used to generate the results. For example, the performance logs 120 can include one or more key performance indicators (KPIs) that measure performance of the respective optimization pipelines in terms of achieving the business objectives, errors observed, feasibility, and the like.

The sustainability optimizer 122 uses AI to read and interpret the existing implementation of an organization's business model as included in the business model data 104 and add one or more sustainability objectives to the business existing business model. For example, one or more sustainability objectives can relate to casing environmental impact, facilitating the conservation of natural resources, and various other types of sustainability objectives, which can vary for different types of organizations. In this regard, the number and type of the sustainability objectives added to the existing business objectives can vary. The level of specificity of the sustainability objectives can also vary. For example, a sustainability objective may include reducing pollution, reducing a specific type of pollution (e.g., air pollution, water pollution, soil pollution, light pollution, etc.) and/or reducing a specific sub-type of pollution (e.g., different types of greenhouse gasses, such as carbon dioxide, nitrous oxide, methane, fluorinated gases, hydrofluorocarbons, etc.). In some embodiments, the sustainability optimizer 122 can automatically infer the one or more sustainability objective or objectives applicable to the organization. For example, the sustainability optimizer 122 can use AI to identify all applicable sustainability cost types that a particular organization's business processes impart on the environment, and/or a subset of the most impactful or important sustainability cost types (e.g., based on relative sustainability cost amounts and/or other criteria that can be used to assess the most imperative sustainability issues for a given organization based on context, such as comparative industry standards, environmental concerns for a particular geographic location, etc.). Additionally, or alternatively, the sustainability optimizer 122 can evaluate how to optimize the existing implementation of an organization's business model with respect to multiple different sustainability objectives collectively and independently. Still in other embodiments, the particular sustainability objective or objectives desired by an enterprise system to be added to their business model can be provided via user input and/or identified in the optimization configuration files 112.

FIG. 1 provides a flow diagram of an example high-level process 124 that can be performed by the sustainability optimizer 122 to automatically integrate one or more sustainability objectives into an existing business model of an enterprise system 102. In this regard, the process 124 performed by the sustainability optimizer 122 can include initially processing input data at 126, wherein the input data can include some or all of the business model data 104 and optionally user input identifying or indicating one or more particular sustainability objectives to add and any constraints and/or optimization criteria for the one or more sustainability objectives. The input data processing at 126 can include for example, parsing the business model data 104 to identify and extract the one or more objective functions 106, the decision variables 108, the constraints 110, the existing optimization configuration files 112, the historical data 114, the use-case specific optimization pipeline 116, the optimization results 118 and the performance log 120. To facilitate this end, the sustainability optimizer 122 can employ one or more existing or future automated data extraction techniques (e.g., natural language processing NLP, crawler engines, key term extraction, etc.) to extract the relevant input data from the business model data 104 and transform the extracted the input data into a structured format for downstream processing. For example, the automated data extraction techniques can involve utilizing natural language processing (NLP), crawler engines configured to perform key term extraction, predictive language models (PLM), decompiles which can read the machine executable code and output the human readable code, and various other similar tools.

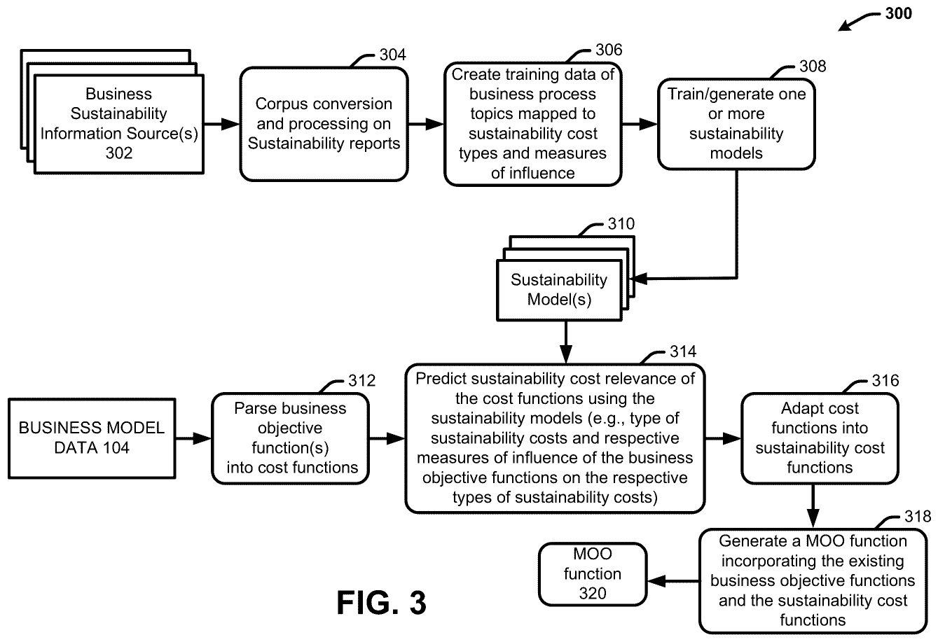

At 128, the sustainability optimizer can extract the existing objective functions 106. For example, the sustainability optimizer 122 can extract the objective functions 106 as provided in the business model data 104 directly in implementations in which they are clearly formulated and defined in the business model data 104. In other implementation, the sustainability optimizer can determine and generate the existing objective functions based on analysis of the decision variables, the constraints 110, the optimization configuration files 112 and/or the historical data 114. At 130, the sustainability optimizer 122 can perform AI based estimation of one or more sustainability objective functions. In various embodiments, this can entail generating one or more additional objective functions for the enterprise system that are additional to the one or more existing objective functions 106, wherein the one or more additional objective functions define relationships between the one or more existing business processes (and/or operations, protocols, etc.) of the enterprise system and one or more sustainability objectives. To facilitate this end, the sustainability optimizer 122 can use one or more first machine learning (ML) processes to evaluate the existing objective functions 106 to estimate whether, to what degree, and/or how the existing sustainability objective functions (and/or the corresponding business processes modeled by the existing sustainability objective functions) influence one or more sustainability objectives. The sustainability optimizer 122 can further reformulate the one or more existing objective functions into sustainability objective functions based on whether, to what degree, and/or how the existing sustainability objective functions influence one or more sustainability objectives, and by replacing the current business objectives targeted by the existing objective functions (e.g., maximizing profits) with one or more sustainability objectives (e.g., reducing carbon emissions for example). Additional information regarding how the sustainability optimizer 122 performs the AI based estimation of the sustainability objective functions is described in greater detail infra with reference to FIGS. 2 and 3.

At 132, the sustainability optimizer 122 can generate a multi-objective optimization (MOO) function that incorporates the one or more existing objective functions 106 and the one or more sustainability objective functions generated at 130. In this regard, the sustainability optimizer 122 can set up an MOO function for the enterprise system that accounts for the one or more existing business objectives of the enterprise system (e.g., maximizing profits, and optional others) and one or more added sustainability objectives for the enterprise system (e.g., reducing carbon emissions for example). At 134, the sustainability optimizer 122 can perform AI based dynamic solver selection. At a high level, this can involve using one or more second machine learning processes to evaluate different existing optimization problem solvers to automatically determine and select the “best” solver applicable to the MOO function with the added sustainability objective based on extracted problem characteristics of the MOO function (e.g., optimization problem formulation type characteristics (e.g., linear/non-linear, convex/non-convex, combinatorial, differentiable/non-differentiable, etc.), constraint characteristics (e.g., linear/non-linear, convex/non-convex, etc.), variable characteristics (e.g., number of variables, continuous/integer variables, etc.). In some implementations, the AI based dynamic solver selection process at 134 can also involve evaluating the performance logs 120 regarding the performance of one or more previously used solvers by the enterprise system in association with solving the objective functions 106 under different use-case specific optimization pipelines and/or criteria. Additional information regarding how the sustainability optimizer 122 performs the AI based dynamic solver selection at 134 is described in greater detail infra with reference to FIGS. 2, 4, and 5.

At 136, the sustainability optimizer 122 can solve the MOO function using the selected solver and generate corresponding results and recommendations 138. For example, the results can include information describing or indicating how the enterprise system can adjust one or more of their business processes to achieve the one or more added sustainability objectives (e.g., reducing carbon emissions, or reducing the amount of carbon emissions by a defined amount as indicated in user input optimization criteria for the particular sustainability objective function). The results can also include information that describes or indicates how different potential changes to the one or more existing business processes impact the one or more sustainability objectives and the one or more existing business objectives respectively (e.g., how do different adjustments resulting in reducing their carbon emissions impact their profit margins for example). Additional information regarding solving the MOO function and generating results and recommendations is described in greater detail infra with reference to FIGS. 2 and 5-8.

FIG. 2 illustrates a block diagram of an example, non-limiting computing system 200 that can facilitate automatically integrating one or more sustainability solutions into an organization's existing business model using AI, in accordance with one or more embodiments described herein. As illustrated in FIG. 2, the sustainability optimizer 122 can be deployed using a computing system 200, which can correspond to any suitable computing system (e.g., real or virtual) comprising or operatively coupled to at least one memory 222 and at least one processing unit 224. In this regard, the sustainability optimizers 122 can correspond to and include one or more computer executable components that can be stored in memory 222 associated with one or more computing systems (e.g., computing system 200) and executed by one or more processors (e.g., processing unit 224) associated with the one or more computing systems (e.g., computing system 200) to perform the operations of the sustainability optimizer 122 as described herein, including process 124 and additional processes described herein. The computing system 200 can further include one or more input and/or output devices 226 that facilitate receiving user input and rendering information to one or more users (e.g., results and recommendations 138) in any suitable output data format (e.g., graphical via a display, audible via a speaker and so on). The computing system 200 can further include a system bus 220 that couples the memory 222, the processing unit 224 and the input/output devices 226 to one another. Examples of the memory 222, the processing unit 224, the input/output device 226 and additional computing elements that may be included and used by the computing system to perform the various operations described with reference to the sustainability optimizer 122 are described with reference to example operating environment 1200 and FIG. 12.

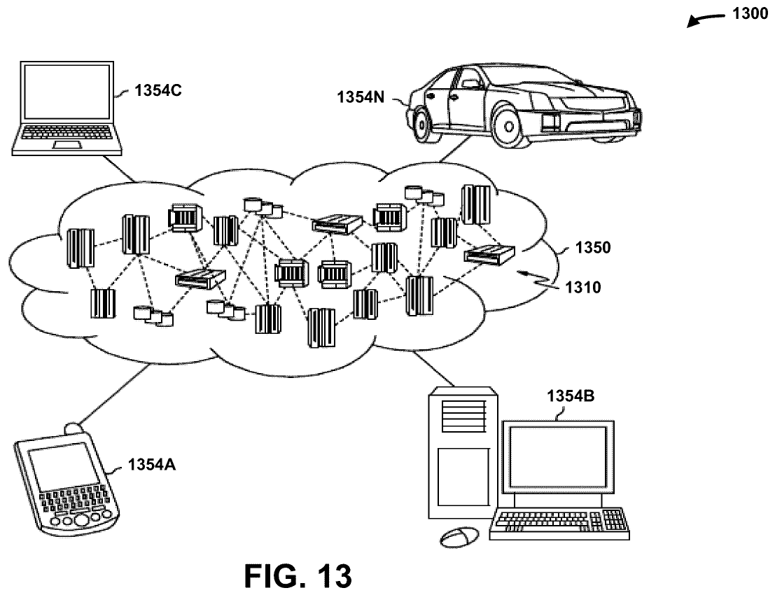

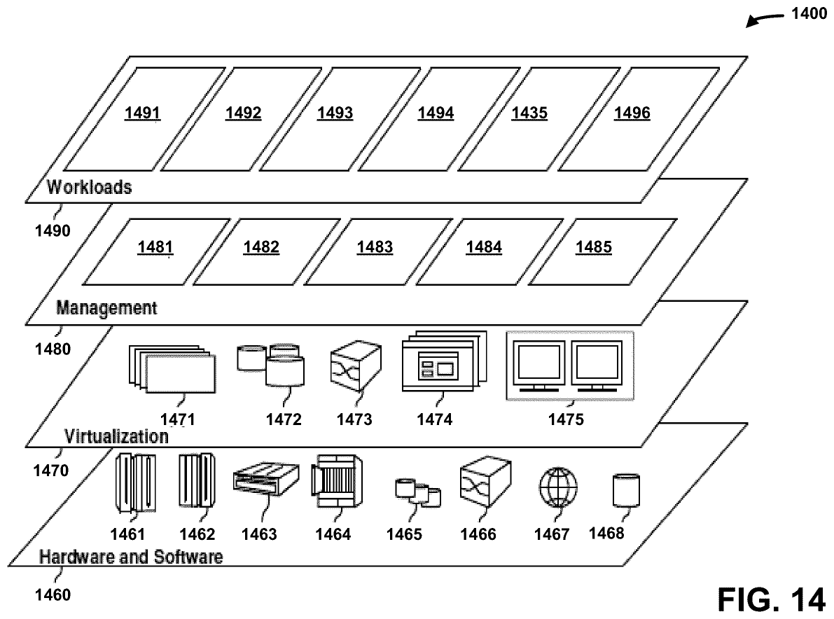

In this regard, with reference to FIGS. 1 and 2, the architecture of system 100 and computing system 200 can vary. In one or more embodiments, the enterprise system 102 and/or the computing system 200 can be associated with a cloud computing environment 1350 described below with reference to FIG. 13 and/or with one or more functional abstraction layers described below with reference to FIG. 14 (e.g., hardware and software layer 1460, virtualization layer 1470, management layer 1480 and/or workloads layer 1490). With these embodiments, the enterprise system 102 and/or sustainability optimizer 122 (and/or components thereof) can employ one or more computing resources of the cloud computing environment 1350 described below with reference to FIG. 13, and/or with reference to the one or more functional abstraction layers (e.g., quantum software and/or the like) described below with reference to FIG. 14, to execute one or more operations in accordance with one or more embodiments described herein. For example, cloud computing environment 1350 and/or one or more of the functional abstraction layers 1460, 1470, 1480 and/or 1490 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by the sustainability optimizer 122 and/or components thereof to execute one or more operations in accordance with one or more embodiments described herein. For instance, the enterprise system 102, the sustainability optimizer 122, and/or components thereof can employ one or more classical and/or quantum computing resources to execute one or more classical and/or quantum: mathematical functions, calculations and/or equations; computing and/or processing scripts; algorithms; models (e.g., AI/ML models corresponding to one more sustainability models 310, one or more optimization problem solver models 416, and/or other analytical models); and/or another operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein can be capable of being implemented in conjunction with any other type of computing environment now known or later developed.

Cloud computing can be a model of service delivery for enabling convenient, on-demand network access to a shared pool of configurable computing resources (e.g., networks, network bandwidth, servers, processing, memory, storage, applications, virtual machines and services) that can be rapidly provisioned and released with minimal management effort or interaction with a provider of the service. This cloud model can include at least five characteristics, at least three service models, and at least four deployment models.

Characteristics can be as follows:

On-demand self-service: a cloud consumer can unilaterally provision computing capabilities, such as server time and network storage, as needed automatically without requiring human interaction with the service's provider.

Broad network access: capabilities can be available over a network and accessed through standard mechanisms that can promote use by heterogeneous thin or thick client platforms (e.g., mobile phones, laptops, and PDAs).

Resource pooling: the provider's computing resources can be pooled to serve multiple consumers using a multi-tenant model, with different physical and virtual resources dynamically assigned and reassigned according to demand. There can be a sense of location independence in that the consumer generally can be without control and/or knowledge over the exact location of the provided resources but can be able to specify location at a higher level of abstraction (e.g., country, state and/or datacenter).

Rapid elasticity: capabilities can be rapidly and elastically provisioned, in one or more cases automatically, to quickly scale out and rapidly released to quickly scale in. To the consumer, the capabilities available for provisioning often can appear to be unlimited and can be purchased in any quantity at any time.

Measured service: cloud systems can automatically control and/or optimize resource use by leveraging a metering capability at one or more levels of abstraction appropriate to the type of service (e.g., storage, processing, bandwidth and active user accounts). Resource usage can be monitored, controlled and/or reported, providing transparency for both the provider and consumer of the utilized service.

Service Models can be as follows:

Software as a Service (SaaS): the capability provided to the consumer can be to use the provider's applications running on a cloud infrastructure. The applications can be accessible from various client devices through a thin client interface such as a web browser (e.g., web-based e-mail). The consumer does not manage or control the underlying cloud infrastructure including network, servers, operating systems, storage or individual application capabilities, with the possible exception of limited user-specific application configuration settings.

Platform as a Service (PaaS): the capability provided to the consumer can be to deploy onto the cloud infrastructure consumer-created or acquired applications created using programming languages and tools supported by the provider. The consumer does not manage or control the underlying cloud infrastructure including networks, servers, operating systems or storage, but can have control over the deployed applications and possibly application hosting environment configurations.

Infrastructure as a Service (IaaS): the capability provided to the consumer can be to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

Deployment Models can be as follows:

Private cloud: the cloud infrastructure can be operated solely for an organization. The cloud infrastructure can be managed by the organization and/or a third party and can exist on-premises or off-premises.

Community cloud: the cloud infrastructure can be shared by one or more organizations and can support a specific community that can have shared concerns (e.g., mission, security requirements, policy and/or compliance considerations). The cloud infrastructure can be managed by the organizations or a third party and can exist on-premises or off-premises.

Public cloud: the cloud infrastructure can be made available to the general public or to a large industry group and can be owned by an organization selling cloud services.

Hybrid cloud: the cloud infrastructure can be a composition of two or more clouds (private, community or public) that can remain unique entities but can be bound together by standardized or proprietary technology that can enable data and/or application portability (e.g., cloud bursting for load-balancing among clouds).

A cloud computing environment can be service-oriented with a focus on statelessness, low coupling, modularity and/or semantic interoperability. At the heart of cloud computing can be an infrastructure that can include a network of interconnected nodes.

Moreover, the non-limiting system 100 and/or computing system 200 can be associated with or can be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, the non-limiting system 100 and/or computing system 200 can be employed to use hardware and/or software to solve problems that are highly technical in nature and/or that are not abstract.

Regardless of the architecture deployment of computing system 200 (and other systems described herein), memory 222 can store one or more computer and/or machine readable, writable and/or executable components and/or instructions that, when executed by processing unit 224 (e.g., a classical processor, a quantum processor and/or like processor), can facilitate performance of operations defined by the executable component(s) and/or instruction(s). For example, memory 222 can store computer and/or machine readable, writable and/or executable components and/or instructions that, when executed by processing unit 224, can facilitate execution of the various functions described herein relating to sustainability optimizer 122 and the respective components of the sustainability optimizer 122, including (but not limited to), extraction component 202, sustainability analysis component 204, optimization formulation component 206, training component 208, training data generation component 210, solver selection component 212, solver application component 214, reporting component 216 and recommendation component 218.

With reference to FIGS. 1 and 2 and the respective computer executable components of the sustainability optimizer 122, the extraction component 202 can extract one or more objective functions (e.g., the objective functions 106, the decision variables 108, the constraints 110 and corresponding optimization configuration files 112) of the enterprise system from the defined business model data 104 for the enterprise system, as described with reference to 128 of process 124. To facilitate this end, the extraction component 202 can use one or more existing or future automated data extraction tools to read and interpret the one or more objective functions from the business model data 104 automatically (e.g., without manual intervention or input). For example, the extraction component 202 can employ natural language processing (NLP), crawler engines configured to perform key term extraction, predictive language models (PLM), decompiles which can read the machine executable code and output the human readable code, and various other similar tools.

As described above, the one or more objective functions 106 can mathematically define relationships between one or more processes of the enterprise system and one or more existing business objectives of the enterprise system. These relationships can vary in complexity depending on the type of the enterprise system, the business objective or objectives, the decision variables 108 and the constraints 110. In various embodiments, the constraints 110 can define and control what elements of the business processes can be adjusted, how, and to what degree (e.g., within a defined value range, within a defined set of values, etc.) in association with optimizing the business objective or objectives.

The sustainability analysis component 204 can infer (e.g., estimate using AI) one or more sustainability costs related to the one or more processes using one or more first machine learning processes. The one or more sustainability costs can respectively correspond to a type of sustainability cost related to the one or more business processes modeled via the corresponding objective functions. For example, the types of sustainability costs can include greenhouse gas emissions, specific types of greenhouse gas emissions, and other types of environment sustainability topics. In some embodiments, in association with inferring the type of sustainability costs related to the one or more business processes, the sustainability analysis component 204 can also infer information regarding how and/or to what degree one or more business processes influence the amount of the type of the sustainability cost (e.g., what is the amount of emission of greenhouse gasses attributed to this business process and/or the weight of contribution of this business processes to the amount of greenhouse gasses emitted). In various embodiments, inferring the one or more sustainability costs by the sustainability analysis component 204 can include or correspond to the AI based estimation of the sustainability objective functions at 130 of process 124.

In this regard, the one or more sustainability costs can represent whether, to what degree and/or how the one or more business processes impact a sustainability objective or objectives targeted for optimization by the enterprise system, wherein the sustainability objective typically includes reducing one or more sustainability costs. For example, a sustainability cost may include or correspond to an amount of carbon emissions, an amount of all greenhouse gases, an amount of utilization of natural resources, etc. In some embodiments, the specific sustainability objective or objectives targeted for optimization by the enterprise system can be predefined (e.g., in the business model data 104) and/or provided via user input (e.g., an entity associated with the enterprise system can provide input requesting solutions for achieving one or more specific sustainability objectives, such as reducing the enterprise systems carbon footprint or another sustainability objective). Additionally, or alternatively, in association with inferring the sustainability costs, the sustainability analysis 204 can estimate what types of sustainability costs are associated with the enterprise system, which may include various types of sustainability costs in various categories.

In various embodiments, the one or more first machine learning processes can involve training, via the training component 208, one or more sustainability models to classify different types of sustainability costs associated with different types of business objective functions and/or business process represented by the different types of business objective functions. In some embodiments, the training component 208 can also train the one or more sustainability models to predict measures of influence of the different types of business objective functions and/or the corresponding business processes on amounts of the different types of sustainability costs. In other words, to predict to what degree (e.g., a weighted value, a percentage, etc.) does a certain business process impact the amount of a particular sustainability cost (e.g., an amount of carbon emission) per month, per year, or another defined timeframe. The one or more sustainability models can include or correspond to machine learning models. The types of the one or more machine learning models can vary. For example, the one or more sustainability models can include or correspond to neural network models, deep neural network models, classification models, and the like.

Once trained, the sustainability analysis component 204 can employ the one or more sustainability models (e.g., as stored in memory 222 or another accessible memory structure) to predict respective types of the one or more sustainability costs related to the one or more business processes (and/or the corresponding objective functions representing the business processes) and respective measures of influence of the one or more objective functions on respective amounts of the respective types of the one or more sustainability costs. In various example embodiments, as applied to reducing an enterprises carbon footprint, the different types of sustainability costs comprise different types of emission classes and the amounts corresponds to emission amounts, however the disclosed techniques can be applied to any type of sustainability subject.

In one or more embodiments, to facilitate training/generating the one more sustainability models, the training data generation component 210 can automatically generate the training dataset used by the training component 208 to train and develop the respective models. The training component 208 can further employ the automatically curated training dataset to train and/or generate the one or more sustainability models using one or more existing machine learning processes (e.g., supervised learning, semi-supervised learning, and/or unsupervised learning processes), which can vary depending on the type or types of ML algorithms used for the sustainability models.

FIG. 3 illustrates a flow diagram of an example, non-limiting process 300 for generating a multi-objective optimization (MOO) function for an enterprise system that integrates one or more sustainability objective functions with one or more existing business objective function for the enterprise system using AI, in accordance with one or more embodiments described herein. With reference to FIGS. 1-3, process 300 incorporates the training dataset generation and the training process for training and generating the one or more sustainability models 310 by the training data generation component 210 and the training component 208, respectively. In accordance with one or more embodiments and process 300, at 302, the training data generation component 210 can access and parse various business sustainability information sources 302 to create the training dataset for training the one or more sustainability models at 306. In various embodiments, the training dataset can include structured information that that maps different types of sustainability costs associated with different types of business process topics (e.g., wherein the business process topics correspond to different business objective functions and/or corresponding business processes) employed by different types of businesses and/or business models of various industries (e.g., energy, agriculture, transport, logistics, food and retail, construction, technology, forestry, medicine, fashion, and various others). For example, the training dataset can map different types of business objective functions and/or corresponding business processes (e.g., transportation processes, manufacturing processes, inventory holding processes, and so on), for different businesses and industries and/or different business processes thereof, to respective types of sustainability costs (e.g., greenhouse gas emission costs, carbon emission costs, water pollution costs, etc.).

In some implementations, as applied to greenhouse gas emissions in particular, the training dataset can map different types of business objective functions and/or corresponding business processes to respective emission classes. For example, the emission classes can include greenhouse gas emission classes as defined by the greenhouse gas (GHG) Protocol Corporate Standard, which classifies a company's GHG emissions into three scopes. Scope 1 emissions are direct emissions from owned or controlled sources. Scope 2 emissions are indirect emissions from the generation of purchased energy. Scope 3 emissions are all indirect emissions (not included in scope 2) that occur in the value chain of the reporting company, including both upstream and downstream emissions. With these implementations, at 308 the training component 208 can train the one or more sustainability models 310 to classify the particular scope of emissions related a particular business objective and/or corresponding business processes based on the labeled training dataset.

In some embodiments in which the one or more sustainability models 310 can predict the measures of influence of the different types of business objective functions (and/or the corresponding business processes and/or topics) on the amounts of the different types of sustainability costs, the training dataset generated at 306 can also include information that maps the maps different types of sustainability costs associated with the different types of business process topics (e.g., wherein the business process topics correspond to different business objective functions and/or corresponding business processes) to measure of influence the business process topics have on the amounts of the sustainability costs. For example, the measure of influence can correspond to weight factors that indicate the relative weight the respective business processes contribute to generating the corresponding sustainability costs.

In this regard, at 304 the training data generation component 210 can automatically generate the training dataset used to train the one or more sustainability models 310 by parsing a corpus of various business sustainability information sources and performing corpus conversion using one or more automated information parsing processes. The one or more business stainability information sources 302 can include (network accessible) open-source documents and sustainability report data associated with different types of business topics and/or corresponding business objective functions used by the respective businesses. For example, in some embodiments, the one or more business sustainability information sources 302 can include open-source sustainability reports made available by the Carbon Disclosure Project (CDP) and similar entities. The CDP is a UK-based not-for-profit operating since 2000 and has offices in 50 countries. Today, cities, states, regions, and companies report to CDP and represent over 90 countries worldwide. Globally, CDP reporting is the most widely used sustainability and carbon disclosure rating system. By reporting to CDP, companies and governmental entities carn a Carbon Disclosure Rating that helps investors incorporate environmental, social, and governance (ESG) indicators into their investment portfolios and sustainable investment strategies. Scores are meant to encourage and guide reporters on their environmental disclosure journey to become industry leaders in transparency and environmental action. All environmental reporting to CDP is openly accessible via CDP's website.

In various embodiments, the one or more automated information parsing processes used at 304 can involve using existing extracting techniques, such as deep searching techniques using NLP, object recognitions, token recognition and the like, to identify and extract known or inferred key terms, words, and phrases related to business topics, business processes, and sustainability topics (e.g., sustainability cost type and amount, relationships or measures between business processes and sustainability cost amounts, etc.) and to transform them into processed, structured outputs. For example, using one or more automated information parsing processes, the training data generation component 210 can extract structured information from various sustainability reports and/or open-source documents correlating the different types of sustainability costs associated with the different types of business objective functions and/or topics and (in some implementations) the measures of influence of the different types of business objective functions or topics to the amounts of the different types of sustainability costs. Using the extracted information, at 306 the training data generation component can generate the training dataset comprising business process topics (and/or business process, and/or corresponding objective functions) to the respective types of sustainability costs and (optionally) the measures of influence.

Once the training data generation component 210 has generated the training dataset, at 308, the training component 208 can employ the training data set to train the one or more sustainability models 310 to predict the type or types of sustainability costs related to a given business objective function or functions (and/or their corresponding business processes or associated business process topics). For example, in some implementations, the training component 208 can train the one or more sustainability models 310 to predict the emissions type and or emissions scope classification related to a given business objective function or corresponding business process represented by the business objective function (e.g., this type of business process for this type of business industry and scale is attributed to Scope 1 emissions for example). In some implementations, the training component 208 can also train the one or more sustainability models 310 to predict a measure of influence or weight of the business process on the amount of the corresponding emissions (e.g., this type of business process for this type of business industry and scale is attributed to 10% of Scope 1 emissions for a particular geographic location annually for example). In some embodiments, the training process can involve domain adaptation of one or more previously trained machine learning models from a previous task in another domain to the sustainability estimation task at hand.

Once the training component has trained the sustainability models 310, the sustainability analysis component 204 can employ them to infer the sustainability costs associated with the one or more business objective functions of the enterprise system being evaluated at 314. For example, in some embodiments, in accordance with process 300, at 312 the sustainability analysis component 204 can infer the one or more sustainability costs by parsing and/or modeling the one or more objective functions 106 as one or more cost functions that formulate the one or more objective functions (and/or the corresponding business processes) as cost functions, that is as a function of financial costs attributed to the one or more processes represented by the one or more objective functions. For example, assume the existing business optimization problem defined for the enterprise system is based on an objective of maximizing profits and thus reducing respective financial costs associated with respective processes employed by the enterprise system. With these embodiments, at 312, the sustainability analysis component 204 can break down the business objective function into one or more cost functions, wherein each cost function represents costs associated with different business processes. For example, as applied to a logistics business that is responsible for planning, managing and implementing the transportation of goods and services, the individual cost functions can include a first cost function (e.g., ordering costs) that represents financial costs associated with product ordering and obtaining products, which includes transportation costs. The cost functions can also include a second function associated with holding or storing the goods (e.g., holding costs), and a third cost function associated with stockout costs, and so on.

With these embodiments, at 314, the sustainability analysis component 204 can apply the one or more sustainability models 310 to each of the separated cost functions to predict the corresponding types of the sustainability costs associated with each cost function based on the corresponding types of businesses processes associated with the respective cost functions. For example, type of sustainability costs associated with respective ordering, holding and stockout processes as applied to the logistics business example. For instance, in some embodiments, as applied to carbon emissions, the respective types of sustainability costs predicted by the one or more sustainability models 310 can include respective emission scope classes related to each of the respective cost functions separated at 312. In some implementations of these embodiments, the measures of influence predicted by the sustainability models 310 here can include weighting factors that indicate the weight of the respective processes on the amount of emissions, wherein the higher the weighting factor the greater the contribution to emissions. In other implementations, the measure of influence can be excluded from the sustainability model predictions and assumed to be accounted for as a function of corresponding to the amounts of financial costs represented in the cost functions (e.g., the greater the financial costs the greater the emissions costs, and vice versa).

In this regard, in some embodiments, at 316, the sustainability analysis component 204 can adapt the one or more cost functions generated at 312 to reformulate them (and/or their corresponding business processes) as a function of the one or more sustainability costs based on the financial costs, the respective types of the one or more sustainability costs and optionally the respective measures of influence. For example, in some implementations, the sustainability analysis component 204 can adapt the cost functions into sustainability cost functions by replacing the cost coefficients with emission factors that reflect the type and amount of emissions attributed to the corresponding business processes. In some embodiments, the emission factors, which represent the weighted contribution of a particular business process to an emission amount, can be predefined and provided in an external database.

At 318, the optimization formulation component 206 can then generation a MOO function 320 for the enterprise system that incorporates the existing business objective functions and the sustainability cost functions (which correspond to the sustainability objective functions). In various embodiments, the existing business objective functions can be modeled in the MOO function as the respective cost functions generated at 312 (e.g., the existing objective functions and the sustainability objective functions can respectively be formulated in the MOO function 312 as cost functions, that is financial cost functions and sustainability cost functions). In this regard, in association with generating the MOO function at 318, the optimization formulation component 206 can generate an MOO function 312 for the enterprise system that formulates potential changes to the one or more processes represented by the one or more existing business objective functions as a function of balancing reducing the one or more sustainability costs and achieving the one or more business objectives. For example, in accordance with formulating the business optimization problem as a function of a combination of the cost functions generated at 312 and the sustainability cost functions generated at 316, the MOO function 320 becomes a problem of finding solutions to changing variable values of the respective functions that results in balancing reducing the one or more sustainability costs modeled in the sustainability cost functions and minimizing financial costs (e.g., costs to the enterprise system) attributed to the existing business processes as modeled as cost functions.

With reference to FIG. 2, the solver application component 214 can further solve the MOO function generated by the optimization formulation component 206 using one or more existing optimization problem solvers (e.g., stored in memory 222 or another network accessible storage location) to determine one or more solutions to the MOO problem. For example, the solver application component 214 can apply one or more existing optimization problems solvers to the MOO function and generate different solutions to the MOO function, the different solutions comprising information describing different changes of the potential changes and resulting impact data indicating how the different changes impact reducing the one or more sustainability costs and achieving the one or more business objectives. In some embodiments, the reporting component 216 can further generate and provide an entity associated with the enterprise system with report data comprising the different solutions in a consumable format. Additionally, or alternatively, the recommendation component 218 can select one or more changes of the different changes based on the impact data associated with the one or more changes satisfying one or more defined optimization criteria for the respective objectives (e.g., a sustainability objective criterion and/or a criterion for the one or more existing business objectives). In other words, the recommendation component 218 can identify and recommend the “best” solution to the MOO function that best balances the existing business objectives and the sustainability objectives under any provided optimization criteria for the respective objectives by the enterprise system (e.g., reduce carbon emissions only to the extent that financial costs are not increased greater than X percent for instance). The recommendation component 218 can further generate and provides an entity associated with the enterprise system recommendation data recommending performance of the one or more selected “best” solutions.

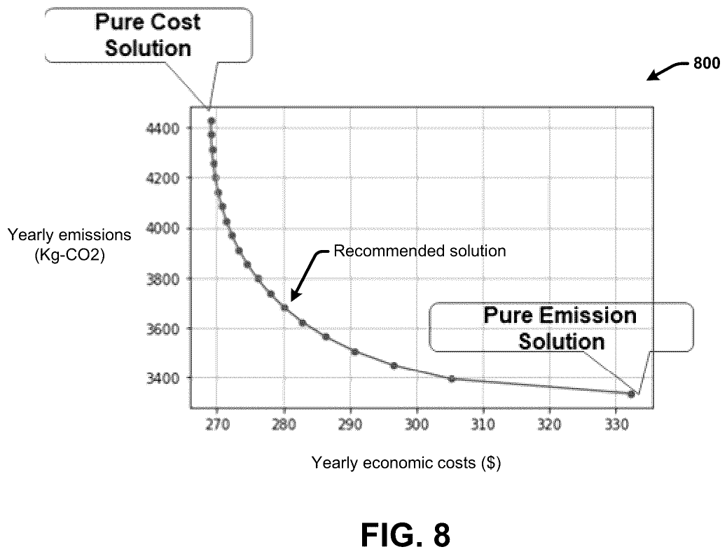

In general, the solutions will reflect how the enterprise system can change one or more aspects of the existing business processes (e.g., represented by the decision variables 108 and/or their values) under the constraints 110 (some of which may also be adapted based on the constraint definitions as provided by the business model data 104) to achieve one or more sustainability goals (e.g., reducing carbon emissions by a certain percentage for instance) while also achieving one or more existing business objectives (e.g., reduce carbon emissions without decreasing profit margins and/or without increasing financial costs, or reduce carbon emissions in association with decreasing profit margins by a maximum defined percentage, and so on). In embodiments in which both the existing objective functions and the sustainability objective functions are modeled to be the same functions yet representing financial costs and sustainability costs respectively), in association with solving the MOO function 320, the sustainability optimizer can generate information that indicates how optimizing one function influences the other, and vice versa (e.g., how optimizing the sustainability cost function from a pure sustainability cost reduction perspective influences financial costs and vice versa). With these embodiments, the reporting component 216 can provide the enterprise system with a range of solution options from which the enterprise system can choose which solution best balances their needs with respect to both objectives (as exemplified in FIG. 8).

With reference to FIGS. 1 and 2, to facilitate solving the MOO function 320 (or the like), in some embodiments, the sustainability optimizer 122 can perform an AI based best solver selection process, as represented by step 134 of process 124. With these embodiments, the solver selection component 214 can extract problem characteristics of the MOO function, and determine, using one or more second machine learning processes, estimated performance characteristics of different optimization problem solvers as applied to solve the MOO function based on the problem characteristics. The solver selection component 214 can further select a solver of the different optimization solvers for solving the MOO function based an analysis of the estimated performance characteristics relative to one or more defined selection criteria (i.e., select the solver with the “best” estimated performance characteristics for the particular MOO function at hand).

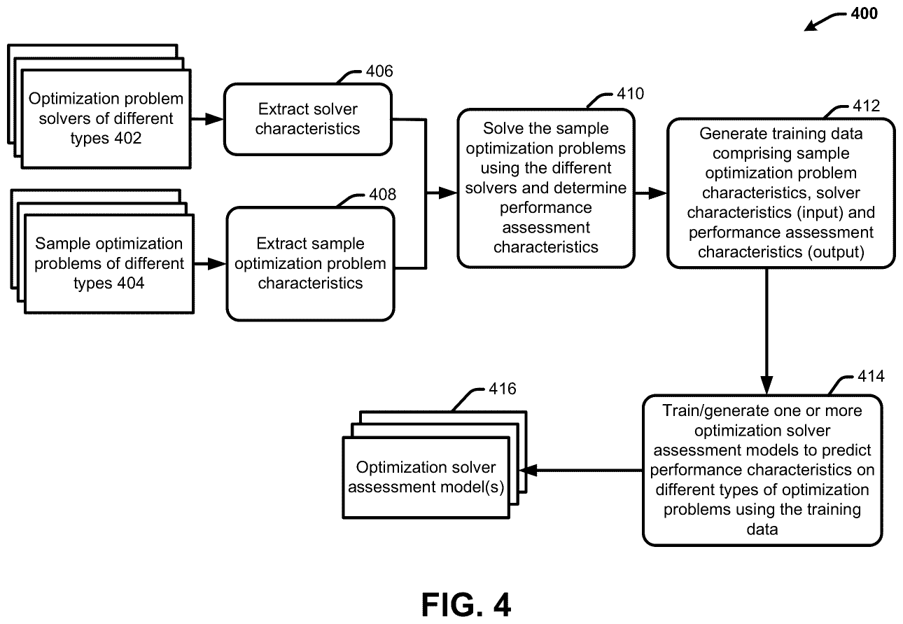

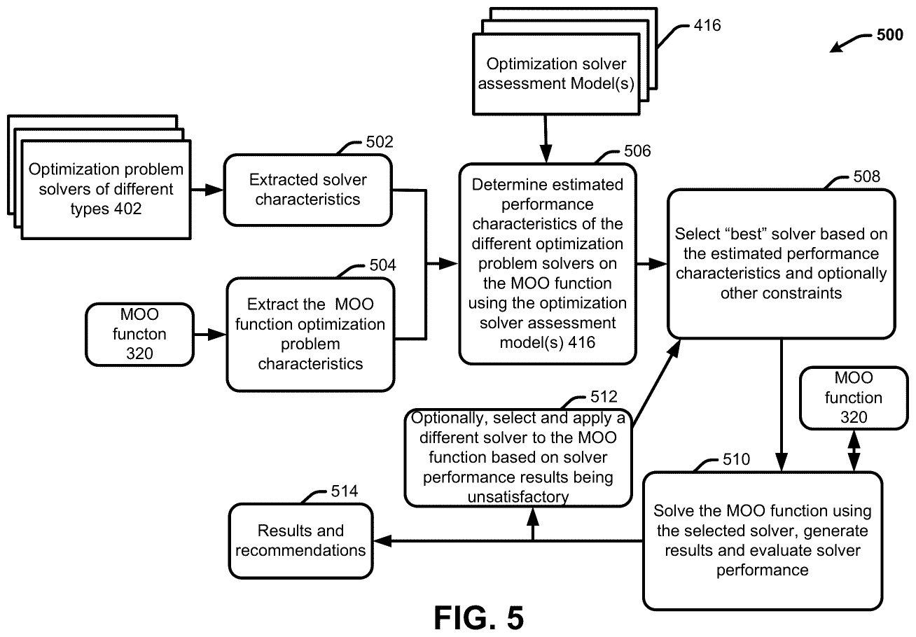

With these embodiments, the one or more second machine learning processes can comprise training, via the training component 208, one or more solver assessment models to predict performance characteristics of the different optimization problem solvers as applied to solve different types of optimizations problems based on known problem characteristics of the different types of optimization problems, known solver characteristics of the different types of optimization solvers, and known performance characteristics the different optimization problem solvers as applied to solve different types of optimizations problems, as illustrated in FIG. 4. Once trained, the solver selection component 214 can employ the one or more solver assessment models to determine the estimated performance characteristics of the MOO function 320 based on the known solver characteristics and the extracted problem characteristics of the MOO function, as illustrated in FIG. 5.

FIG. 4 illustrates a flow diagram of an example, non-limiting machine learning process 400 for generating one or more optimization solver assessment models in accordance with one or more embodiments described herein. With reference to FIGS. 1-4, process 400 can correspond to the one or more second machine learning processes described above. In accordance with process 400, the training data generation component 210 can generate a training dataset for training one or more optimization problem solver assessment models 416 from a set of available optimization problem solvers of different types (hereinafter solvers 402) and a set of sample optimization problems of different types (hereinafter sample optimization problems 404). The solvers 402 can respectively correspond to existing software programs that incorporate one or more computer executable algorithms and/or processes for finding solutions to optimization problems. The solvers 402 can include open-source solvers, proprietary solvers (which may require licensing agreements for usage thereof), and non-proprietary solvers. There are many different existing optimization solvers available for solving different types of optimization problems (e.g., hundred to thousands or more). Some examples include CPLEX™, Gurobi™, Mosek™, Xpress™, and Pulp™ to name a few. In addition, there are many different types or classifications of optimization problem formulations. For example, optimization problems can be classified in accordance with various classes or characteristics, such as but not limited to: linear, non-linear, convex, non-convex, combinatorial, differentiable, non-differentiable, continuous, discrete, unconstrained, constrained, deterministic, stochastic, and many other classifications.

In accordance with process 400, a 402, the training data generation component 210 can analyze and extract characteristics of the respective solvers 402, such as algorithm or algorithms used, solvability space, whether its parallelizable, and various other characteristics. The extracted solver characteristics can also include information identifying any costs associated with utilization thereof (e.g., whether they are open-source and/or require fees for usage thereof). At 404, the training data generation component 210 can also analyze and extract respective characteristics of the sample optimization problems. For example, the characteristics can include one or more classification labels for the respective sample optimization problems (e.g., whether each particular problem is linear, non-linear, convex, non-convex, combinatorial, differentiable, non-differentiable, continuous, discrete, unconstrained, constrained, deterministic, stochastic, etc.). The characteristics can also include constraint characteristics (e.g., linear, non-linear, convex, non-convex, etc., the number of variables, the type of variables (e.g., continuous, integer, etc.), and number of objective functions involved. In preferred embodiments, the sample optimization problems can correspond to MOO problems that incorporate two or more objective functions, however the sample optimization problems 404 are not limited to MOO problems.

At 410, the solver application component 214 can solve the sample optimization problems 404 using the different solvers (e.g., solve each optimization problem using each solver) and determine performance assessment characteristics of each problem and solver combination. For example, the performance assessment characteristics can include one or more measure of errors, performance success and/or failure, performance quality, computation speed, feasibility, and other types of performance assessment characteristics. In some embodiments, these performance characteristics may be included in and extracted from log files generated by the respective solvers. In other embodiments, these performance characteristics can be extracted by the solver application component using AI techniques. At 412, the training data generation component 210 can then generate a training data that indexes the respective sample optimization problems, and for each optimization problem the characteristics of each solver applied, and the corresponding performance assessment characteristics of that solver as applied to the optimization problem. At 414, using the training data, the training component 208 can then train one or more optimization problem solvers to predict the performance characteristics of the different optimization problem solvers as applied to the respective sample problems 402. In this regard, in association with training the solver assessment models 416 (e.g., one or more ML models trained using supervised learning with the known performance assessment characteristics as the ground truth data) the input to the optimization solver assessment models 416 can include the combination of a set of solver characteristics (or the unique solver name or identifier tied to the known solver characteristics of that solver), and a set of optimization problem characteristics for a known optimization problem, and the output can be the predicted performance assessment characteristics (which is compared to the corresponding ground truth data, and wherein the models are trained using one or more loss functions, such as Dice loss or another suitable loss function). Once convergence has been reached and the one or more optimization solver assessment models 416 have been trained, the optimization solver assessment models can be used to predict the performance characteristics of the different solvers 402 respectively on new MOO functions (e.g., MOO function 320 and the like), using the corresponding known solver characteristics and extracted problem characteristics of the new MOO functions, as illustrated in FIG. 5.

In this regard, FIG. 5 illustrates a flow diagram of an example, non-limiting process 500 for solving a MOO function using AI, in accordance with one or more embodiments described herein. With reference to FIGS. 1-5, in accordance with process 500, the extracted solver characteristics corresponding to those extracted at 406 of process 400 and included in the training data generated at 412, are represented as extracted solver characteristics 502. At 504, the solver selection component 212 can extract the MOO function optimization problem characteristics (e.g., for MOO function 320 or the like). At 506, the solver application component 214 can determine estimated performance characteristics of respective solvers of the different solvers 402 using the one or more optimization problem solvers with the input being for each solver evaluated being the extracted MOO function characteristics and the corresponding solver characteristics. For example, the estimated performance characteristics can include information that provides estimated measure of errors, performance success and/or failure, performance quality, computation speed, feasibility, and other types of performance assessment characteristics of each particular solver of the respective solvers 402 evaluated on the MOO function. At 508, the solver selection component can select the “best” solver of the different solvers 402 based on estimated performance characteristics using counterfactual analysis, and optionally based on other constraints when applicable (e.g., licensing agreements for usage thereof, whether the enterprise system agrees to fees for usage thereof, and so on). For example, the solver selection component 212 can select the best solver based on that solver having the best estimated performance characteristics relative to the other solvers and/or another defined criterion for determining the best solver based on the estimated solver characteristics. At 510, the solver application component can then solve the MOO function (e.g., MOO function 320) using the selected solver, and generate the corresponding optimization results and recommendations 514 (corresponding to the results and recommendations generated at 138 of process 124). In some embodiments, and optionally evaluate the solver performance on the MOO function. In some embodiments, prior to generating the results and recommendations 514, at 512 the solver selection component 212 may optionally select and apply a different solver to the MOO function based on the previously selected solver generating unsatisfactory performance results (e.g., errors, computational processing delay, and other potential performance issues associated with the previously selected solver). With these embodiments, the solver selection component 212 can select the “next best” solver at 508, and process 500 can continue in a loop with respect to steps 508, 510 and 512, until a suitable solver is found.

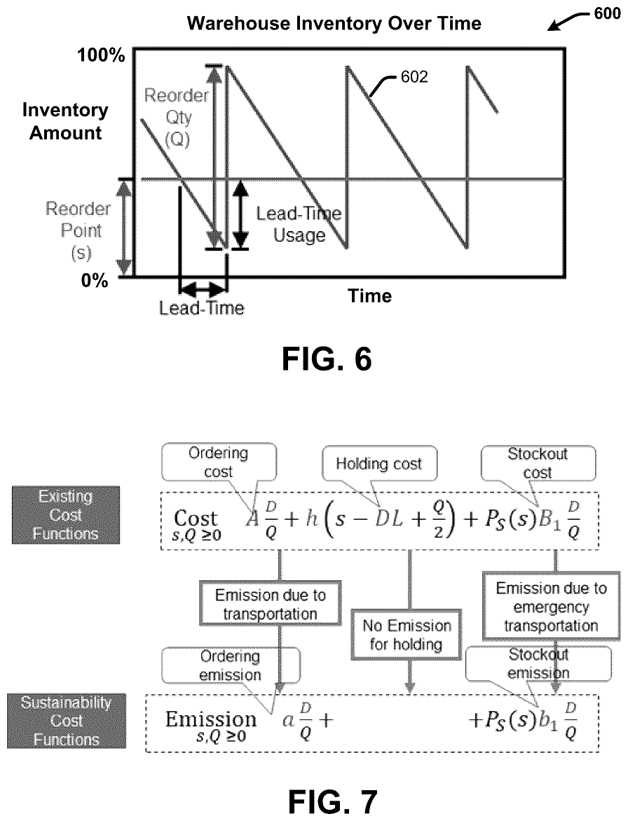

FIG. 6 presents a graph 600 illustrating an example process of an example logistics business in accordance with one or more example embodiments described herein. In accordance with graph 600, the logistics business corresponds to a business that is responsible for planning, managing and implementing the transportation of goods and services. In this example, the process of the logistic business modeled in graph 600 corresponds to how the logistic business operates a warehouse in association with ordering, holding, and stocking out inventory over time. Line 602 plots how the inventory amount changes overtime with respect to being at 100% capacity and 0% capacity. In this example, the process of the logistics business is evaluated with respect to two decision variables, including: 1.) when to re-order more inventory, referred to as the re-order point (ROP. (s)), and 2.) how much inventory to re-order, referred to as the re-order quantity (ROQ, (Q)). As illustrated in graph 600, over the course of operation of the warehouse, after a full quantity of inventory is ordered and received, the warehouse inventory is at high capacity (e.g., at or near 100% depending on the amount ordered). Thereafter, the amount of inventory slowly depletes (e.g., as it is purchased, delivered, used, etc.). Additional inventory is then reordered at some point prior to the inventory amount falling below a threshold amount, which is the ROP. The ROP is typically set to accommodate the amount of time (i.e., the lead time) it takes to receive the newly ordered inventory such that there is enough inventory left to for usage over this time (i.e., the lead-time usage amount).

In accordance with this example and the disclosed techniques, the business problem for the logistics business can be formulated as two objective functions, that is: 1.) how to set the optimal ROP, and 2.) how to set the optimal ROQ. With reference to FIGS. 1-6, in accordance with this example, these two objective functions correspond to examples of objective functions 106 that can be included in the business model data 104 for this logistics business. As applied to this example, the objective functions 106 can include information that describes the relationships between the decision variables ROP(s) and ROQ (Q) and the processes of the logistic business, including the ordering, holding, and stocking out processes. The objective functions 106 can also include information that defines relationships between the respective process and any additional decision variables and constraints on the respective processes (e.g., included in decision variables 110 and the constraints 112). In accordance with this example, the additional decision variables or constraints include financial costs associated with ordering, holding and stocking out inventory.

As applied to the disclosed techniques, in accordance with process 124, at 128 the extraction component 202 can extract the objective functions for the logistics business from the business model data 104, along with existing optimization criteria for the business, which in this example is assumed to be minimizing financial costs. At 130, the sustainability optimizer 122 then estimates the sustainability objective function or functions based on the existing objective functions. In accordance with this example, the sustainability optimizer 122 can estimate the sustainability objective functions as described with reference to FIG. 3 and process 300. In this regard, the sustainability analysis component 204 can parse the business objective functions into cost functions (e.g., as described with reference to step 312). The sustainability analysis component 204 can then employ one or more sustainability models 310 to predict the type of sustainability cost associated with each cost function (e.g., step 314). As applied to this example, let's assume the sustainability costs of interest to the logistics business is carbon emissions. To this end, the sustainability analysis component 204 can employ the one or more emission scope classes related to each of the cost functions. The sustainability analysis component 204 can then adapt the existing cost functions into sustainability cost functions by replacing the existing cost coefficients with corresponding emission factors. An example of the existing cost functions and the corresponding sustainability cost functions for this logistics business as generated by the sustainability optimizer in accordance with the process described above is illustrated in FIG. 7.

With reference to FIG. 7, the existing cost functions for the logistic business in this example are broken down into an ordering cost function, holding cost function, and a stockout cost function. In this regard, the financial costs to the logistic business are formulated as an aggregate of these three cost functions. The variables s and Q respectively represent the ROP and the ROQ, and wherein D represents financial costs, A represents the ordering costs coefficient, L represents the holding costs coefficient, B1 represents the stockout costs coefficient, and wherein the additional variables h and Ps represent defined constraints. In this example, the existing cost functions are reformulated into corresponding sustainability cost functions by replacing the cost coefficients with new coefficients corresponding to emission factors respectively associated with each cost function. In this example, the emissions cost coefficient associated with the ordering costs is represented by “a”, the emissions cost coefficient associated with the holding cost was estimated to be zero, thus eliminating this function from the sustainability costs functions, and the stockout cost emissions coefficient is represented as “b1.”

With reference again to FIGS. 1-7, the existing cost functions and the sustainability cost functions illustrated in FIG. 7 can be combined to form a MOO function (e.g., corresponding to MOO function 320) by the optimization formulation component 206, wherein in accordance with this example, the optimization problem involves finding the best values for s, and Q (i.e., the ROP and the ROQ) by solving the combined existing cost functions and the sustainability cost functions, wherein the “best” values are determined based on the optimization criteria, which in this case include reducing carbon emissions and reducing financial costs to the logistics system associated with ordering, holding and stocking out inventory.

FIG. 8 presents a graph 800 illustrating the impact of different optimization solutions to the MOO function defined by the existing cost functions and the corresponding sustainability cost functions illustrated in FIG. 7 for the logistics business problem. With reference to FIGS. 1-8, graph 800 demonstrates a range of potential solutions to the MOO function from a pure cost solution to a pure emissions solution. In this example, using a selected optimization problem solver (e.g., selected in accordance with process 500 for example), the solver application component 214 solved the MOO function in association with determining different values for s and Q under a range of optimization criteria, from solely minimizing financial cost to solely minimizing carbon emissions. In this regard, each dot plotted along the curve corresponds to a different combination of values for s and Q as represented by the resulting effect of each combination of values on the amount of financial costs per year and the amount of carbon emissions per year. Graph 800 corresponds to an example solutions summary chart that can be generated by the reporting component 216 and provided to an entity associated with the logistics business to understand how different changes to operations of their logistics business (e.g., s and Q in this example) impact carbon emissions and financial costs. In accordance with chart 800, the “best” solution to the MOO function for the logistics business can be selected by the entity based on the business's criteria for balancing both objectives. For example, the “best” solution may correspond to the recommended solution (e.g., determined by the recommendation component 218) which the yearly economic costs are increased only slightly (e.g., from 270 to 280) yet the carbon emissions are reduced significantly (e.g., by more than about 50%). In this regard, the recommended solution balances both objectives. It should be appreciated that criteria controlling what is the “best” solution to this example MOO function (e.g., targets for emission amount reductions under defined financial constraints) and other MOO functions generated by the sustainability optimizer 122 can be predefined based on user input and/or otherwise inferred by the recommendation component 128 and can vary.

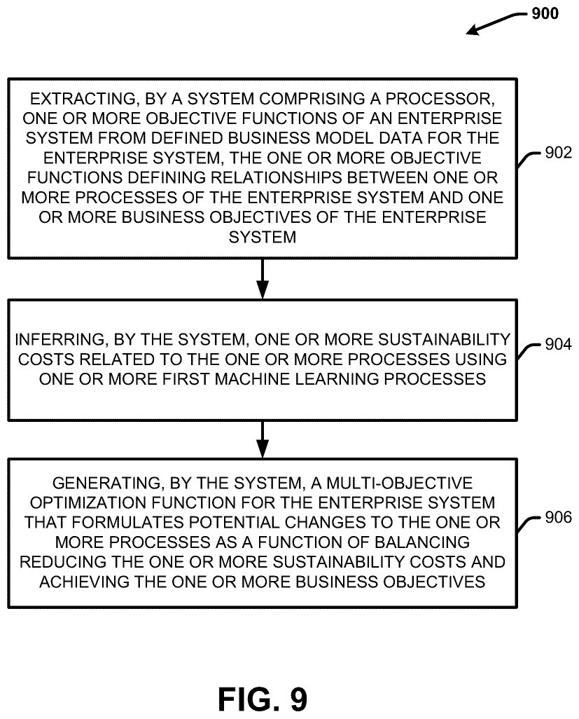

FIG. 9 illustrates a flow diagram of an example, non-limiting computer-implemented method 900 for automatically integrating one or more sustainability solutions into an organization's existing business model using AI in accordance with one or more embodiments described herein. Method 900 comprises, at 902 extracting, by a system comprising a processor (e.g., system 100, computing system 200 or the like), one or more objective functions of an enterprise system from defined business model data for the enterprise system, the one or more objective functions defining relationships between one or more processes of the enterprise system and one or more business objectives of the enterprise system (e.g., via extraction component 202). At 904, method 900 comprises inferring, by the system, one or more sustainability costs related to the one or more processes using one or more first machine learning processes (e.g., via sustainability analysis component 204 and training component 208). At 906, method 900 comprises generating, by the system, a multi-objective optimization (MOO) function for the enterprise system that formulates potential changes to the one or more processes as a function of balancing reducing the one or more sustainability costs and achieving the one or more business objectives (e.g., via optimization formulation component 206).

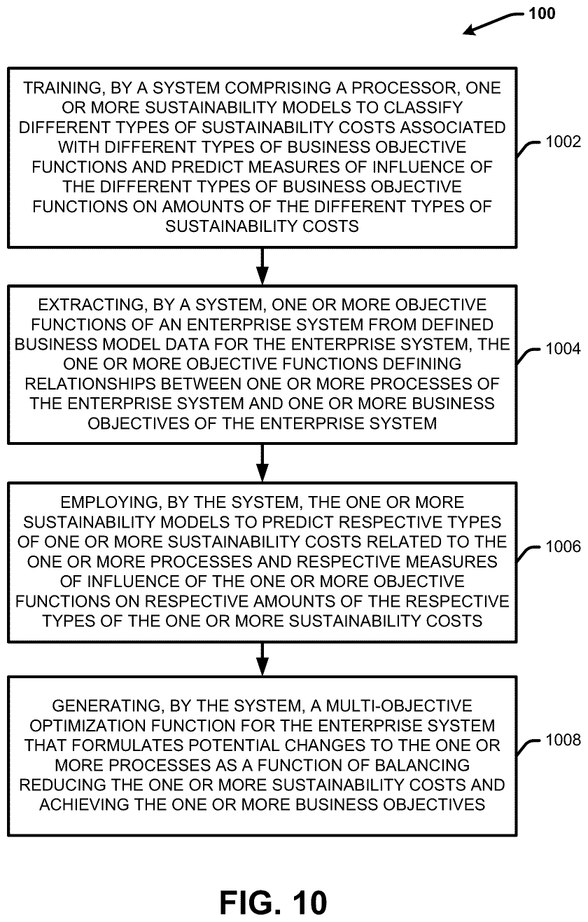

FIG. 10 illustrates a flow diagram of another example, non-limiting computer-implemented method 700 for automatically integrating one or more sustainability solutions into an organization's existing business model using AI in accordance with one or more embodiments described herein. In accordance with method 1000, at 1002 a system comprising a processor (e.g., system 100, computing system 200 or the like), can train (e.g., via training component 208) one or more sustainability models to classify different types of sustainability costs associated with different types of business objective functions and predict measure of influence of the different types of business objective functions on amounts of the different types of sustainability costs. At 1004, method 1000 comprises extracting one or more objective functions of an enterprise system from defined business model data for the enterprise system, the one or more objective functions defining relationships between one or more processes of the enterprise system and one or more business objectives of the enterprise system (e.g., via extraction component 202). At 1006, method 1000 comprises employing, by the system, the one or more sustainability models to predict respective types of one or more sustainability costs related to the one or more processes and respective measure of influence of the one or more objective function on respective amounts of the respective types of sustainability costs (e.g., via sustainability analysis component 204). At 1008, method 1000 comprises generating, by the system, a multi-objective optimization (MOO) function for the enterprise system that formulates potential changes to the one or more processes as a function of balancing reducing the one or more sustainability costs and achieving the one or more business objectives (e.g., via optimization formulation component 206).

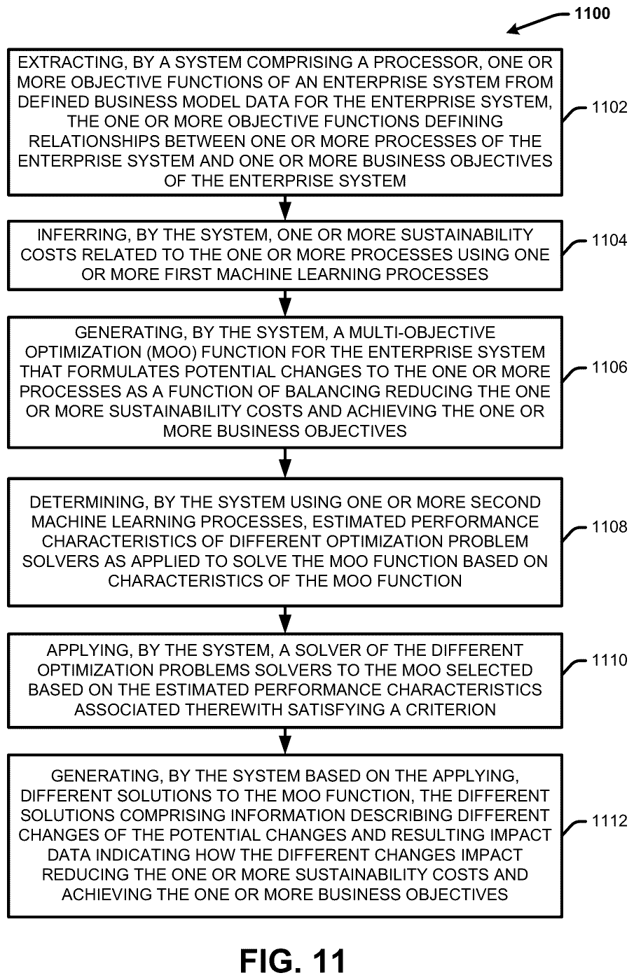

FIG. 11 illustrates a flow diagram of another example, non-limiting computer-implemented method 1100 for automatically integrating one or more sustainability solutions into an organization's existing business model using AI in accordance with one or more embodiments described herein. Method 1100 comprises, at 1102 extracting, by a system comprising a processor (e.g., system 100, computing system 200 or the like), one or more objective functions of an enterprise system from defined business model data for the enterprise system, the one or more objective functions defining relationships between one or more processes of the enterprise system and one or more business objectives of the enterprise system (e.g., via extraction component 202). At 1104, method 1100 comprises inferring, by the system, one or more sustainability costs related to the one or more processes using one or more first machine learning processes (e.g., via sustainability analysis component 204 and training component 208). At 1106, method 1100 comprises generating, by the system, a multi-objective optimization (MOO) function for the enterprise system that formulates potential changes to the one or more processes as a function of balancing reducing the one or more sustainability costs and achieving the one or more business objectives (e.g., via optimization formulation component 206).

At 1108, method 1100 comprises determining, by the system using one or more second machine learning processes, estimated performance characteristics of different optimization problem solvers as applied to solve the MOO function based on characteristics of the MOO function (e.g., via training component 208 and solver selection component 212). At 1110, method 1100 comprises applying, by the system, a solver of the different optimization problem solvers to the MOO selected based on the estimated performance characteristics associated therewith satisfying a criterion (e.g., via solver selection component 212). At 1112, method 1100 further comprises generating, by the system based on the applying, different solutions to the MOO based on the applying, the different solutions comprising information describing different changes of the potential changes and resulting impact data indicating how the different changes impact reducing the one or more sustainability costs and achieving the one or more business objectives.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

In one or more embodiments, one or more of the processes described herein can be performed by one or more specialized computers (e.g., a specialized processing unit, a specialized classical computer, a specialized quantum computer and/or another type of specialized computer) to execute defined tasks related to the various technologies identified above. System 100, computing system 200 and/or components thereof, can be employed to solve new problems that arise through advancements in technologies mentioned above, employment of quantum computing systems, cloud computing systems, computer architecture and/or another technology.

According to one or more embodiments, system 100, computing system 200 and/or components thereof, also can be fully operational towards performing one or more other functions (e.g., fully powered on, fully executed and/or another function) while also performing the various operations described herein.

In order to provide additional context for various embodiments described herein, FIG. 12 and the following discussion are intended to provide a brief, general description of a suitable operating environment 1200 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures and/or the like that perform particular tasks and/or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located both in local and remote memory storage devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, disk storage and/or other magnetic storage devices, solid state drives and/or other solid state storage devices, and/or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, but not limitation, communication media can include wired media, such as a wired network and/or direct-wired connection, and/or wireless media such as acoustic, RF, infrared and/or other wireless media.

With reference again to FIG. 12, the example operating environment 1200 for implementing various embodiments of the aspects described herein includes a computer 1202, the computer 1202 including a processing unit 1206, a system memory 1204 and/or a system bus 1208. The system bus 1208 can couple system components including, but not limited to, the system memory 1204 to the processing unit 1206. The processing unit 1206 can be any of various commercially available processors. Dual microprocessors and/or other multi-processor architectures can be employed as the processing unit 1206.

The system bus 1208 can be any of one or more types of bus structure that can further interconnect to a memory bus (with or without a memory controller), a peripheral bus and/or a local bus using any of a variety of commercially available bus architectures. The system memory 1204 can include ROM 1210 and/or RAM 1212. A basic input/output system (BIOS) can be stored in a non-volatile memory such as ROM, erasable programmable read only memory (EPROM) and/or EEPROM, which BIOS contains the basic routines that help to transfer information among elements within the computer 1202, such as during startup. The RAM 1212 can also include a high-speed RAM, such as static RAM for caching data.

The computer 1202 further can include an internal hard disk drive (HDD) 1214 (e.g., EIDE, SATA), one or more external storage devices 1216 (e.g., a magnetic floppy disk drive (FDD), a memory stick or flash drive reader, a memory card reader and/or the like) and/or a drive 1220, e.g., such as a solid state drive or an optical disk drive, which can read or write from a disk 1222, such as a CD-ROM disc, a DVD, a BD and/or the like. Alternatively, where a solid state drive is involved, disk 1222 could not be included, unless separate. While the internal HDD 1214 is illustrated as located within the computer 1202, the internal HDD 1214 can also be configured for external use in a suitable chassis (not shown). Additionally, while not shown in operating environment 1200, a solid state drive (SSD) could be used in addition to, or in place of, an HDD 1214. The HDD 1214, external storage device(s) 1216 and drive 1220 can be connected to the system bus 1208 by an HDD interface 1224, an external storage interface 1226 and a drive interface 1228, respectively. The HDD interface 1224 for external drive implementations can include at least one or both of Universal Serial Bus (USB) and Institute of Electrical and Electronics Engineers (IEEE) 13124 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more applications 1232, other program modules 1234 and/or program data 1236. All or portions of the operating system, applications, modules and/or data can also be cached in the RAM 1212. The systems and methods described herein can be implemented utilizing various commercially available operating systems and/or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In a related embodiment, operating system 1230 can comprise one virtual machine (VM) of multiple VMs hosted at computer 1202. Furthermore, operating system 1230 can provide runtime environments, such as the JAVA runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and/or settings for an application.

Further, computer 1202 can be enabled with a security module, such as a trusted processing module (TPM). For instance, with a TPM, boot components hash next in time boot components and wait for a match of results to secured values before loading a next boot component. This process can take place at any layer in the code execution stack of computer 1202, e.g., applied at application execution level and/or at operating system (OS) kernel level, thereby enabling security at any level of code execution.

A user entity can enter commands and information into the computer 1202 through one or more wired/wireless input devices, e.g., a keyboard 1238, a touch screen 1240 and/or a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices can be connected to the processing unit 1206 through an input device interface 1244 that can be coupled to the system bus 1208, but can be connected by other interfaces, such as a parallel port, an IEEE 13124 serial port, a game port, a USB port, an IR interface, a BLUETOOTH® interface and/or the like.

A monitor 1246 or other type of display device can be also connected to the system bus 1208 via an interface, such as a video adapter 1248. In addition, a computer typically includes other peripheral output devices (not shown), such as speakers, printers and/or the like.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device and/or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 and/or can be connected to a communications server on the WAN 1256 via other means for establishing communications over the WAN 1256, such as by way of the Internet. The modem 1260, which can be internal or external and a wired and/or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link among the computers can be used.

When used in either a LAN or WAN networking environment, the computer 1202 can access cloud storage systems or other network-based storage systems in addition to, or in place of, external storage devices 1216 as described above, such as but not limited to, a network virtual machine providing one or more aspects of storage or processing of information. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf and/or the like), and/or telephone. This can include Wireless Fidelity (Wi-Fi) and BLUETOOTH® wireless technologies. Thus, the communication can be a predefined structure as with a conventional network or simply an ad hoc communication between at least two devices.

Referring now to FIG. 13, an illustrative cloud computing environment 1350 is depicted. As shown, cloud computing environment 1350 includes one or more cloud computing nodes 1310 with which local computing devices used by cloud consumers, such as, for example, personal digital assistant (PDA) or cellular telephone 1354A, desktop computer 1354B, laptop computer 1354C and/or automobile computer system 1354N can communicate. Although not illustrated in FIG. 13, cloud computing nodes 1310 can further comprise a quantum platform (e.g., quantum computer, quantum hardware, quantum software and/or the like) with which local computing devices used by cloud consumers can communicate. Cloud computing nodes 1310 can communicate with one another. They can be grouped (not shown) physically or virtually, in one or more networks, such as Private, Community, Public, or Hybrid clouds as described hereinabove, or a combination thereof. This allows cloud computing environment 1350 to offer infrastructure, platforms and/or software as services for which a cloud consumer does not need to maintain resources on a local computing device. It is understood that the types of computing devices 1354A-N shown in FIG. 13 are intended to be illustrative only and that cloud computing nodes 1310 and cloud computing environment 1350 can communicate with any type of computerized device over any type of network and/or network addressable connection (e.g., using a web browser).

Referring now to FIG. 14, a set of functional abstraction layers is shown, such as provided by cloud computing environment 1350 (FIG. 13). It should be understood in advance that the components, layers and functions shown in FIG. 14 are intended to be illustrative only and embodiments described herein are not limited thereto. As depicted, the following layers and corresponding functions are provided:

Hardware and software layer 1460 can include hardware and software components. Examples of hardware components include: mainframes 1461; RISC (Reduced Instruction Set Computer) architecture-based servers 1462; servers 1463; blade servers 1464; storage devices 1465; and networks and networking components 1466. In one or more embodiments, software components can include network application server software 1467, quantum platform routing software 1468 and/or quantum software (not illustrated in FIG. 14).

Virtualization layer 1470 can provide an abstraction layer from which the following examples of virtual entities can be provided: virtual servers 1471; virtual storage 1472; virtual networks 1473, including virtual private networks; virtual applications and/or operating systems 1474; and/or virtual clients 1475.

In one example, management layer 1480 can provide the functions described below. Resource provisioning 1481 can provide dynamic procurement of computing resources and other resources that can be utilized to perform tasks within the cloud computing environment. Metering and Pricing 1482 can provide cost tracking as resources are utilized within the cloud computing environment, and billing or invoicing for consumption of these resources. In one example, these resources can include application software licenses. Security can provide identity verification for cloud consumers and tasks, as well as protection for data and other resources. User (or constituent) portal 1483 can provide access to the cloud computing environment for consumers and system administrators. Service level management 1484 can provide cloud computing resource allocation and management such that required service levels are met. Service Level Agreement (SLA) planning and fulfillment 1485 can provide pre-arrangement for, and procurement of, cloud computing resources for which a future requirement is anticipated in accordance with an SLA.

Workloads layer 1490 can provide examples of functionality for which the cloud computing environment can be utilized. Non-limiting examples of workloads and functions which can be provided from this layer include: mapping and navigation 1491; software development and lifecycle management 1492; virtual classroom education delivery 1493; data analytics processing 1494; transaction processing 1495; and/or application transformation software 1496.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and/or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry or either source code or object code written in any combination of one or more programming languages, including an object oriented programming language such as Smalltalk, C++, or the like, and/or procedural programming languages, such as the “C” programming language or similar programming languages. The computer readable program instructions can execute entirely on the user's computer, partly on the user's computer, as a stand-alone software package, partly on the user's computer and/or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, and/or other device to cause a series of operational acts to be performed on the computer, other programmable apparatus or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and operation of possible implementations of systems, computer-implementable methods and/or computer program products according to various embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions and/or acts or carry out combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with other program modules. Generally, program modules include routines, programs, components, data structures and/or the like that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and/or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the disclosed memory components of systems and/or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the one or more embodiments, but one of ordinary skill in the art can recognize that many further combinations and permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
an extraction component that extracts one or more objective functions of an enterprise system from defined business model data for the enterprise system, the one or more objective functions defining relationships between one or more processes of the enterprise system and one or more business objectives of the enterprise system;
a sustainability analysis component that infers one or more sustainability costs related to the one or more processes using one or more first machine learning processes; and
and an optimization formulation component that generates a multi-objective optimization function for the enterprise system that formulates potential changes to the one or more processes as a function of balancing reducing the one or more sustainability costs and achieving the one or more business objectives.

2. The system of claim 1, wherein the computer executable components further comprise a training component and wherein the one or more first machine learning processes comprise:
training, via the training component, one or more sustainability models to classify different types of sustainability costs associated with different types of business objective functions and predict measures of influence of the different types of business objective functions on amounts of the different types of sustainability costs; and
employing, via the sustainability analysis component, the one or more sustainability models to predict respective types of the one or more sustainability costs related to the one or more processes and respective measures of influence of the one or more objective functions on respective amounts of the respective types of the one or more sustainability costs.

3. The system of claim 2, wherein the different types of sustainability costs comprise different types of emission classes and wherein the amounts correspond to emission amounts.

4. The system of claim 2, wherein the sustainability analysis component infers the one or more sustainability costs by:
modeling the one or more objective functions as one or more cost functions that formulate the one or more processes as a function of financial costs attributed to the one or more processes; and
adapting the one or more cost functions to reformulate the one or more processes as a function of the one or more sustainability costs based on the financial costs, the respective types of the one or more sustainability costs and the respective measures of influence.

5. The system of claim 2, wherein the computer executable components further comprise a training data generation component and wherein the one or more first machine learning processes comprise:
generating, via the training data generation component, a training dataset that maps the different types of sustainability costs associated with the different types of business objective functions and the measures of influence of the different types of business objective functions on the amounts of the different types of sustainability costs, and wherein the training comprises training the one or more sustainability models using the training dataset.

6. The system of claim 5, wherein the generating the training dataset comprises parsing, via the training data generation component using one or more automated information parsing processes, open-source documents and sustainability report data associated with different types of business objective functions and extracting structured information correlating the different types of sustainability costs associated with the different types of business objective functions and the measures of influence of the different types of business objective functions to the amounts of the different types of sustainability costs.

7. The system of claim 1, wherein the computer executable components comprise:
a solver selection component that:
extracts problem characteristics of the multi-objective optimization function, and
determines, using one or more second machine learning processes, estimated performance characteristics of different optimization problem solvers as applied to solve the multi-objective optimization function based on the problem characteristics, and
selects a solver of the different optimization solvers for solving the multi-objective optimization function based an analysis of the estimated performance characteristics relative to one or more defined selection criteria.

8. The system of claim 7, wherein the computer executable components further comprise:
a solver application component that applies the solver to the multi-objective optimization function based on selection thereof and generates different solutions to the multi-objective optimization function using the solver, the different solutions comprising information describing different changes of the potential changes and resulting impact data indicating how the different changes impact reducing the one or more sustainability costs and achieving the one or more business objectives.

9. The system of claim 8, wherein the computer executable components further comprise:
a recommendation component that selects one or more changes of the different changes based on the impact data associated with the one or more changes satisfying a sustainability criterion and generates and provides an entity associated with the enterprise system recommendation data recommending performance of the one or more changes based on the selecting.

10. The system of claim 7, wherein the computer executable components further comprise a training component and wherein the one or more second machine learning processes comprise:
training, via the training component, one or more solver assessment models to predict performance characteristics of the different optimization problem solvers as applied to solve different types of optimizations problems based on known problem characteristics of the different types of optimization problems, known solver characteristics of the different types of optimization solvers, and known performance characteristics the different optimization problem solvers as applied to solve different types of optimizations problems, and
wherein the solver analysis component employs the one or more solver assessment models to determine the estimated performance characteristics of the multi-objective optimization function based on the known solver characteristics and the problem characteristics of the multi-objective optimization function.

11. The system of claim 10, wherein the computer executable components further comprise a training data generation component and wherein the one or more second machine learning processes comprise:
applying, by the training data generation component, the different optimization problem solvers to solve the different types of optimizations problems to generate the known performance characteristics the different optimization problem solvers;
extracting, by the training data generation component, the known problem characteristics of the different types of optimization problems based on analysis of the different types of optimization problems; and
extracting, by the training data generation component, the known solver characteristics of the different types of optimization solvers based on analysis of the different types of optimization solvers.

12. A computer-implemented method, comprising:
extracting, by a system comprising a processor, one or more objective functions of an enterprise system from defined business model data for the enterprise system, the one or more objective functions defining relationships between one or more processes of the enterprise system and one or more business objectives of the enterprise system;
inferring, by the system, one or more sustainability costs related to the one or more processes using one or more first machine learning processes; and
generating, by the system, a multi-objective optimization function for the enterprise system that formulates potential changes to the one or more processes as a function of balancing reducing the one or more sustainability costs and achieving the one or more business objectives.

13. The computer-implemented method of claim 12, wherein using the one or more first machine learning processes comprises:
training, by the system, one or more sustainability models to classify different types of sustainability costs associated with different types of business objective functions and predict measures of influence of the different types of business objective functions on amounts of the different types of sustainability costs; and
employing, by the system, the one or more sustainability models to predict respective types of the one or more sustainability costs related to the one or more processes and respective measures of influence of the one or more objective functions on respective amounts of the respective types of the one or more sustainability costs.

14. The computer-implemented method of claim 12, wherein the different types of sustainability costs comprise different types of emission classes and wherein the amounts correspond to emission amounts.

15. The computer-implemented method of claim 12, wherein the inferring comprises:
modeling the one or more objective functions as one or more cost functions that formulate the one or more processes as a function of financial costs attributed to the one or more processes; and
adapting the one or more cost functions to reformulate the one or more processes as a function of the one or more sustainability costs based on the financial costs, the respective types of the one or more sustainability costs and the respective measures of influence.

16. The computer-implemented method of claim 12, wherein using the one or more first machine learning processes further comprises:
generating, by the system, a training dataset that maps the different types of sustainability costs associated with the different types of business objective functions and the measures of influence of the different types of business objective functions on the amounts of the different types of sustainability costs, wherein the training comprises training the one or more sustainability models using the training dataset, and wherein the generating the training dataset comprises:
parsing, by the system component using one or more automated information parsing processes, open-source documents and sustainability report data associated with different types of business objective functions and extracting structured information correlating the different types of sustainability costs associated with the different types of business objective functions and the measures of influence of the different types of business objective functions to the amounts of the different types of sustainability costs.

17. The computer-implemented method of claim 12, further comprising:
extracting, by the system, problem characteristics of the multi-objective optimization function;
determining, by the system using one or more second machine learning processes, estimated performance characteristics of different optimization problem solvers as applied to solve the multi-objective optimization function based on the problem characteristics, and
selecting, by the system, a solver of the different optimization solvers for solving the multi-objective optimization function based an analysis of the estimated performance characteristics relative to one or more defined selection criteria.

18. The computer-implemented method of claim 17, further comprising:
applying, by the system, the solver to the multi-objective optimization function based on selection thereof; and
generates, by the system, different solutions to the multi-objective optimization function based on the applying, the different solutions comprising information describing different changes of the potential changes and resulting impact data indicating how the different changes impact reducing the one or more sustainability costs and achieving the one or more business objectives.

19. The computer-implemented method of claim 17, wherein using the one or more second machine learning processes comprises:
training, by the system, one or more solver assessment models to predict performance characteristics of the different optimization problem solvers as applied to solve different types of optimizations problems based on known problem characteristics of the different types of optimization problems, known solver characteristics of the different types of optimization solvers, and known performance characteristics the different optimization problem solvers as applied to solve different types of optimizations problems; and
employing, by the system, the one or more solver assessment models to determine the estimated performance characteristics of the multi-objective optimization function based on the known solver characteristics and the problem characteristics of the multi-objective optimization function.

20. A computer program product that facilitates integrating one or more sustainability solutions into an organization's existing business model using artificial intelligence, the computer program product comprising a computer readable storage medium having program instructions embodied therewith, the program instructions executable by a processor to cause the processor to:
extract one or more objective functions of an enterprise system from defined business model data for the enterprise system, the one or more objective functions defining relationships between one or more processes of the enterprise system and one or more business objectives of the enterprise system;
infer one or more sustainability costs related to the one or more processes using one or more first machine learning processes; and
generate a multi-objective optimization function for the enterprise system that formulates potential changes to the one or more processes as a function of balancing reducing the one or more sustainability costs and achieving the one or more business objectives.
